(19) United States
(12) Patent Application Publication
(10) Pub. No.: US 2014/0362563 A1
(43) Pub. Date: Dec. 11, 2014

(54) Fixtures for large area directional and isotropic solid state lighting panels

(71) Applicants: Scott M. Zimmerman, Basking Ridge, NJ (US); William R. Livesay, San Diego, CA (US); Richard L. Boss, Del Mar, CA (US); Eduardo DeAnda, San Diego, CA (US); Chad R. Livesay, Encinitas, CA (US); Karl W. Beeson, Princeton, NJ (US)

(72) Inventors: Scott M. Zimmerman, Basking Ridge, NJ (US); William R. Livesay, San Diego, CA (US); Richard L. Boss, Del Mar, CA (US); Eduardo DeAnda, San Diego, CA (US); Chad R. Livesay, Encinitas, CA (US); Karl W. Beeson, Princeton, NJ (US)

(21) Appl. No.: 13/986,793

(22) Filed: Jun. 5, 2013

(51) Int. Cl. F21V 29/00

(52) U.S. Cl. CPC F21V 29/004
USPC 362/147

(57) ABSTRACT

Reflector designs for a large area panel light source create induced draft cooling means adjacent to the panel light source. The panel light source has a wavelength conversion element on a solid state light source for emitting light of a first and second wavelength to form a broader emission spectrum of light from the panel light source.

### REFERENCE TO PRIOR APPLICATIONS

This application is a continuation-in-part of U.S. patent application Ser. No. 12/380,439, filed on Feb. 27, 2009 for “Fixtures For Large Area Directional And Isotropic Solid State Lighting Panels”, which claims the benefit of U.S. Provisional Patent Application Ser. No. US61/067,934, filed on Mar. 1, 2008, which is commonly assigned as the present application and herein incorporated by reference.

This application is also a continuation-in-part of U.S. patent application Ser. No. 13/572,608, filed on Aug. 10, 2012, for “Solid State Light Sources Based On Thermally Conductive Luminescent Elements Containing Interconnects”, which claims the benefit of U.S. Provisional Patent Application Ser. No. 61/574,925, which was filed on Aug. 11, 2011, which is commonly assigned as the present application and herein incorporated by reference.

This application is also a continuation-in-part of U.S. patent application Ser. No. 13/506,015, filed Mar. 21, 2012, for “Self-Cooling Solid State Emitters”, which claims the benefit of U.S. Provisional Patent Application Ser. No. 61/465,611, which was filed on Mar. 21, 2011, which is commonly assigned as the present application and herein incorporated by reference.

This application is also a continuation-in-part of U.S. patent application Ser. No. 12/807,770, filed Sep. 13, 2010, for “Wavelength Conversion Chip For Use With Light Emitting Diodes And Method For Making Same”, which is a continuation-in-part of U.S. patent application Ser. No. 11/975,406 entitled “Wavelength Conversion Chip In Solid-State Lighting And Method For Making Same,” filed Oct. 19, 2007, which was a continuation-in-part of U.S. Patent Application Ser. No. 11/389,311 entitled “Wavelength Conversion Chip In Solid-State Lighting And Method For Making Same,” filed Mar. 24, 2006, which is commonly assigned as the present application and herein incorporated by reference.

This application is also a continuation-in-part of U.S. Pat. No. 7,293,908 for “Side Emitting Illumination Systems Incorporating Light Emitting Diodes”, which is commonly assigned as the present application and herein incorporated by reference.

### BACKGROUND OF THE INVENTION

Panel light fixtures are typically designed to take into account the light distribution, intensity, and thermal characteristics of the source. Panel light fixtures have historically been incandescent light bulbs or fluorescent light bulbs. A wide range of reflectors and optical devices have been developed over the years to generate a particular output distribution and/or deliver maximum efficiency for an incandescent light bulb.

Fluorescent light bulbs work differently than incandescent light bulbs. An incandescent light has electricity pass through a filament, which emits light. A fluorescent light is a gas discharge light where electricity excites mercury vapor, which emits ultraviolet light. The ultraviolet light strikes phosphors in the fluorescent light, which in turn emit visible light. Fluorescent light bulbs have the added need of ballasts or other electronic methods of converting the available power into a useful form. Fluorescent light bulbs use different reflectors and different optical devices from an incandescent light bulb to achieve a similar result of a particular output distribution and/or maximum efficiency for a fluorescent bulb.

A new light source based on a distributed array of light emitting diodes (LEDs) within a solid luminescent element has been disclosed in U.S. Pat. No. 7,285,791, commonly assigned as the present application and herein incorporated by reference. Electricity passes through an active region of semiconductor material to emit light in a light emitting diode. The solid luminescent element is a wavelength conversion chip. US Published Patent Applications 20080042153 and 20080149166, commonly assigned as the present application and herein incorporated by reference, teach wavelength conversion chips for use with light emitting diodes. A light emitting diode, such as those in US Published Patent Applications 20080182353 and 20080258165, commonly assigned as the present application and herein incorporated by reference, will emit light of a first wavelength and that first wavelength light will be converted into light of a second wavelength by the wavelength conversion chip. U.S. Pat. No. 7,293,908, commonly assigned as the present application and herein incorporated by reference, discloses a thin side illumination system with embedded LED die, commonly assigned as the present application and herein incorporated by reference. A recycling cavity and LED die with reflectivity greater than 40% enable the efficient coupling of light into a side illuminating structure with a thickness less than 2 mm.

A panel light source can be made in a variety of shapes and output distributions ranging from directional to isotropic using thermally conductive luminescent elements. Power conditioning and control electronics can also be incorporated into the bulb itself because the thermally conductive luminescent element is a solid. A variety of means can also be used to connect to the available power source. In addition, the distributed nature of the sources allows for cooling via natural convection means as long as sufficient airflow is allowed by the light fixture eliminating or greatly reducing the need for additional heatsinking means. It also provides a substrate for integration of solar and energy storage means.

In most cases, existing LED light sources are based on high intensity point sources, which required extensive thermal heatsinking to operate and distribute the heat generated in the point sources over a large area. The localized nature of these high intensity point sources dictate that large heatsinks must be used especially in the case of natural convection cooled applications. While 100 lumen/watt performance levels have been demonstrated for bulbs outside the fixture, performance can degrade as much as 50% once this type of solid state light source is used inside the fixture due to airflow restriction and lack of ventilation. This is especially true for the cases where fixtures are surrounded by insulation, as is the case for most residential applications. The heatsinks typically required to cool these high intensity point sources are both heavy and present a hazard especially in overhead lighting applications, where a falling light could severely injure a passerby. Additionally, the fact that the source is so localized means that some type of distribution or diffusing means must be used to deal with the brightness level generated. This is required from an aesthetic and safety point of view. The small nature of the source means that imaging of the source on the retina of the eye is of great concern. This is especially true for UV and blue sources due to additive photochemical effects. In general, brightness levels greater than 5,000 to 10,000 FtL are uncomfortable for direct viewing especially at night. High intensity point sources can be several orders of magnitude higher brightness than what can be comfortably viewed directly. Lastly, the localized nature of the heat source generated by these high intensity point sources dictate that high efficiency heat sink designs must be used which are more susceptible to dust and other environmental effects especially in outside applications. This dictates periodic maintenance of the light sources, which is impractical in many cases. The need therefore exists for improved fixtures that can provide directional control, allow cooling of the sources, and safely illuminate our homes and businesses. Panel lights based on thermally conductivity luminescent elements are disclosed which enable new types of light fixtures and are ideally suited for general illumination applications.

A suspended ceiling represents a large percentage of the commercial, office and retail space. In this particular application, 2 foot×2 foot and 2 foot×4 foot grids are suspended from the ceiling and acoustic/decorative tiles are suspended by the t shaped grid pieces. Lighting has typically been 2×2 or 2×4 troffers which similarly are suspended on the T shaped grid pieces. The troffers are wired to the AC bus lines above the suspended ceiling. Each troffer consists of a sheet metal housing, driver, light sources, and reflective and diffusive elements. In the case of solid state troffers, additional heatsinking means or cooling means may also be incorporated into each troffer. In general a standard troffer requires a minimum volume of 1 cubic foot for a 2×2 and 2 cubic feet for a 2×4. The typical lumen output is 2000 lumens for a 2×2 troffer and 4000 lumens for a 2×4. In many instances the location of the light fixtures are put on a regular spacing even though uniform lighting throughout the area may not be required or desirable. This is driven by the difficulty and costs associated with relocating the troffers once installed. This leads to excess lighting with its associated energy losses. The need exists for lightweight diffuse and directional lighting fixtures for suspended ceilings that can be relocated easily and upgraded or changed as technology advances.

Recently, Armstrong has introduced its 24 VDC DC FlexZone grid system. The T-shaped grid pieces provide 24 VDC connections on both the top and bottom of the grid pieces. The availability of 24 VDC eliminates the need for a separate drivers and ballasts for solid state lighting. The elimination or simplification of the driver allows for very lightweight and low volume light fixtures especially for the cases where self cooling solid state light sources are employed. Lightweight and low volume translate directly into reduced raw material usage, fixture cost, warehousing costs, and shipping costs. By eliminating fixed metal housings and replacing them with modular and interchangeable optical and lighting elements that directly attach to an electrical grid system like Armstrong's DC FlexZone system costs can be reduced not only for the fixture itself but also for the cost associated with changing the lighting.

Close to 2 billion square feet of commercial and retail suspended ceiling space is remodeled or created each year. The need exists for more flexibility in how this space can be reconfigured. Present fixtures require addition support to the deck of the building due to weight and size constraints per seismic building codes. The need exists for field installable and user replaceable lighting fixtures that can be seismically certified with the grid so that the end user can adjust and reposition fixtures as the need arises. Under the present requirements, any changes to the lighting requires that the ceiling panels be removed and at a minimum additional support wires must be installed to the building deck before the fixture can be repositioned. This may also require a re-inspection of the ceiling in addition to the added cost for the change. The need exists for lightweight, robust lighting that can be easily adjusted by the end user without the need for recertification and outside labor.

In evaluating the weight of light modules, it is useful to utilize the concept of lumens per gram. Reducing the lumens per gram of light fixtures can have a major impact on manufacturing costs due to reduce materials costs. It could also allow for fixtures which can be directly attached to the grid of a suspended ceiling and still meet seismic standards without requiring additional support structures which are commonly needed for existing troffer type light sources

The need also exists for aesthetically pleasing high lumen per gram light fixtures. For many applications, the lighting should be present but not draw attention to itself. This is not the case with troffers which immediately draw attention away from the other parts of the ceiling. Therefore there is a need for lightweight and compact lighting fixtures which address the above needs in suspended ceiling applications.

Again the thickness of the lighting module has a direct impact on the aesthetics of the installation. Existing linear solid state sources require large mixing chambers to spread the light emitted by the LEDs this dramatically increase the depth of these light sources. In order for light panel modules to have a an emitting surface close to the plane of the ceiling and not to protrude into the room or office space below, the major portion of the light source module must be recessed into the suspension ceiling.

The need exists for low profile, or thin lighting panels with thicknesses under 10 mm which are attachable to the electrified grids. Ideally these lighting panels would be field replaceable from the office space side of the installation by end users (and not require custom installers) and present an aesthetically pleasing and monolithic and uniform appearance. Essentially the ideal suspension ceiling lighting system would “disappear” into the ceiling from an aesthetic standpoint.

### SUMMARY OF THE INVENTION

According to the present invention, a solid state light source, such as a light emitting diode, an organic light emitting diode, an inorganic light emitting diode, an edge emitter light emitting diode, a vertical cavity surface emitting laser, or a laser diode, and a thermally conductive luminescent element, such as a wavelength conversion element or a phosphor element, with a reflector means will form a panel light fixture. The solid state light source is typically a point light source of a single wavelength but the panel light fixture transmits light of a broader emission spectrum over a large area.

Unlike conventional solid state light sources, the disclosed sources emit light through the thermally conductive luminescent element while simultaneously providing cooling from the thermally conductive luminescent element to the surrounding ambient. This is especially important for suspended ceiling applications because it eliminates: the need for thermal attachment to the grid, the need for additional heatsinking means, or the use of cooling means above the ceiling tiles such as fans, plenums, or headspace. This approach is unaffected by whether or not the ceiling is insulated or not. Conventional solid state lighting such as canlights, troffers, or array/waveguide based panel lights must operate at lower output levels if the ceiling is insulated due to the fact that they rely on a substantial portion of their heat load to be dissipated above the ceiling tiles. By creating sources in which the majority of the heat is transferred to the surrounding ambient by the emitting surface these deficiencies are overcome. As an example, a 3 inch×½ inch×1 mm thick strip light consisting of translucent polycrystalline alumina (TPA) with a thermal conductivity of 30 W/m/k can contain several direct attach UV/Blue LED die which are soldered directly to the thermally conductive translucent material (e.g TPA, Spinel, etc.) as disclosed in the named inventors of this invention's cited referenced applications and patents. A rear reflective element or waveguide or combination of both redirects, diffuse, and mixes the light emitted by the UV/Blue LED such that the light emitted by the UV/Blue LED is redirected out through the thermally conductive translucent material . In the process of this re-direction wavelength conversion can be accomplished. Wavelength conversion can occur within, on, or reflectively to the thermally conductive translucent material or element as will be further disclosed below. The resulting light source emits the majority of it's light from the thermally conductive translucent element's surface while also spreading the heat generated by the LEDS and transferring the heat to the ambient below the ceiling tiles. The result is an aesthetically pleasing light strip which does not require additional heatsinking means but also meets the lumens per gram level sufficient for unsupported mounting to the grid and simultaneously meet seismic restrictions.

This disclosure covers a variety of reflector designs for panel light sources and configuration of panel lights containing thermally conductive luminescent elements. The panel light sources disclosed in this invention consist of at least one thermally conductive luminescent element to which at least one solid state light source is attached, and an interconnect means. The at least one thermally conductive luminescent element converts at least a portion of the light emitted from the at least one solid state light source into a broader emission spectrum, but it also serves to diffuse/distribute the light generated as well as provide a cooling path for itself and the at least one solid state light source to the surrounding ambient via convection off the surface of the at least one thermally conductive luminescent element. More preferably, the at least one thermally conductive luminescent element enables the formation of panel lights which can be directly viewed with human eye without the need for further diffusion or protective means.

The thermally conductive luminescent element may or may not contain, within its volume, wavelength conversion means as previously disclosed. The use of additional external conversion means especially reflective wavelength conversion means is disclosed. This may be used in combination with luminescent means on the surface of the thermally conductive luminescent element, as a layer of the thermally conductive luminescent element, or within the bulk of the thermally conductive luminescent element. The main functions of the thermally conductive luminescent elements are to provide a support/substrate for the direct attach LED die or LED packages, provide a support for the electrical interconnect used to connect the direct attach LED die or LED packages used in the light source, diffuse and distribute the light emitted by the direct attach LED die or LED packages, a support/substrate for electrical contacts or connectors to the electrified grid, heat spreading element for the direct attach LED die or LED packages, heat transfer element to surrounding ambient, and optionally wavelength conversion of the light emitted by the direct attach LED die or LED packages, support or attachment means to the grid, and/or support/attachment element for additional aesthetic or optical elements including but not limited to reflectors, waveguides, decorative elements, lens, shrouds, shades, or diffusers.

The use of freestanding epitaxial chips as the solid state light sources is preferred for both directional and isotropic panel lights. The combination of the panel lights and solar conversion and/or energy storage means is a preferred embodiment of this invention. In this manner, compact light sources can be created which do not require external power sources. Heat extraction to the ambient can be directional or isotropic as well. In general the emitting surface is also the cooling surface.

The use of at least one of these panel light sources in a fixture is a preferred embodiment of this invention. Both directional (lambertian and narrower angular distribution) and isotropic sources are disclosed in a variety of fixtures. Fixture design can create induced draft cooling channels around or in proximity to the panel light.

As most suspended ceiling tiles provide acoustical and thermal isolation, they tend to be insulative and lightweight. The use of recycled paper and slag from steel production in the form of spun wools is common. These materials inhibit the effective use of the grid as a heatsink means for the same reasons that conventional solid state light fixtures typically have to be derated for insulated ceilings. Disclosed herein and is the transfer of the majority of the heat generated by the light source fixture to the ambient below the ceiling tiles. Even more preferred is that the cooling surface and emitting surface are substantially the same. The disclosed fixtures may be linear source that attach on the grid, or are incorporated into the ceiling tile, and/or combinations of both. The use of additional optical elements including but not limited to reflectors, lenses, diffusers, waveguides, or decorative elements are also included. The use of suspending elements to space the disclosed fixtures below the grid or tiles such that pendant lights can be formed is also disclosed. In addition, the use of these fixtures in sidewalls and flooring to form sconces, wallwasher, decorative strips, or emergency lighting when a DC grid are incorporated into those sidewalls and floors is also disclosed. The light sources are extremely light and compact which enables them to easily snap, clip, or magnetically attach, or to adhere to the grid. The use of these sources to enable modular units of light that can be expanded or minimized by the end user without the need to remove ceiling tiles is most preferred.

The panel light may also contain a connector and mounting clip for attachment to suspended ceiling grid containing DC electrical distribution systems. Attachment may be via magnetic, mechanical, or spring based means for support of the fixture. The attachment means may also contain electrical contacts or a separate method of electrical contact may be used. Both waveguide and airguided panel lights containing self-cooling solid state light sources are disclosed. As previously disclosed in the cited relevant references, the authors of this invention has disclosed sources with greater than 30 lumens/gram and are most preferred. The lightweight of the sources and self-cooling nature of the sources greatly reduces the weight and cost of the overall lighting fixture. The lightweight allows for safe suspension of even large area panel lights from the channel within the grids. This eliminates the need for troffers with their associated sheet metal housings, reflectors, diffusers and heatsinks and additional superstructure and mounting wires.

Other aspects of the invention will become apparent from the following more detailed description, taken in conjunction with the accompanying drawings.

### BRIEF DESCRIPTION OF THE DRAWINGS

FIG. 1 is a side view of a lambertian directional panel light source of the present invention.

FIG. 2 is a side view of an isotropic panel light source of the present invention.

FIG. 3 is a side view of a wall washer based on a lambertian panel light with induced draft cooling flow of the present invention.

FIG. 4 is a side view of a trough light with an isotropic linear panel light source and flow through cooling of the present invention.

FIG. 5 is a side view of a light panel for improved reflector design of the present invention.

FIG. 6 is a side view of a magnetic connector for lambertian panels for ceiling lighting of the present invention.

FIG. 7 is a side view of a self cooling light panel with integrated energy storage and energy generation means.

FIG. 8 is a side view of a prior art solid state troffer mounted in a T grid.

FIG. 9 is a side view of a prior art DC T grid.

FIG. 10 is a side view of a suspended ceiling panel light.

FIGS. 11A and 11B are side views of a suspended ceiling linear light containing multiple self cooling solid state light sources located near the focal point of a reflective optical element.

FIG. 12 is a side view of suspended ceiling panel light with a central support member and heat transfer element.

FIG. 13 is a side view of suspended ceiling linear array with a waveguide integrated into a ceiling tile.

FIG. 14 is a side view of grid array with separate dimming circuits.

FIG. 15 is a side view of grid array with field replaceable light sources.

FIG. 16 is a side view of pendant for suspended ceilings based on self cooling light sources.

FIG. 17 is a top down view of a magnetic contact and support for grids.

FIG. 18 is a side view of field replaceable panel light for suspended ceilings.

FIG. 19 is a side view of suspended ceiling panel light with an additional integrated sensor unit for dimming, fire, occupancy, and temperature.

FIG. 20 is a side view of a self-cooling solid state light source radially isotropic source connected to a DC T grid.

FIG. 21 is a single stick hanging vertically downward with an optional 3D CPC reflector.

FIG. 22 is a side view of a self-cooling solid state light source with additional decorative elements supported by the self-cooling solid state light source.

FIG. 23 is a side view of grid mounted wall sconce.

FIG. 24 is a side view of a floor mounted lighting strip based on an embedded grid.

FIG. 25 is a side view of a magnetic twist connector for grid based strip lighting.

FIG. 26 is a side view of a translucent thermally conductive diffuser element based on boron nitride composites.

FIG. 27 is a side view of a strip light with an interchangeable decorative overlay.

FIG. 28A and 28B are side views of a spring based connector for grid lighting.

FIG. 29 is a side view of an integrated IR/WIFI controller for grid strip lighting.

FIG. 30 is a side view of a RGB strip light.

FIG. 31 is a side view of an embedded self cooling light within a ceiling tile.

FIG. 32A and 32B are graphs of thermal conductivity of heat spreading elements versus FtL/lumens per inch for horizontal and vertical lighting sources.

FIG. 33 is a side view of a directive elements attached to grid based strip lighting.

FIG. 34 is a side view of a colored thermal diffuser element with optional luminescent layer.

FIG. 35A, 35B, 35C and 35D are side views of optional grid contacts for self-cooling strip lighting.

FIG. 36A and 36B are side views of a self-cooling light panel.

FIG. 37A, 37B and 37C depict side views of alternate configurations of self-cooling light panel.

FIGS. 38a and 38B depict side views of a directional self cooling light panels.

FIG. 39A and 39B depict side views of a central controlling module for self cooling light panels.

FIG. 40 depicts a side view of a self-cooling light panel within a perforated ceiling tile.

FIG. 41A, 41B and 41C depict side views of various self-cooling surface emitters for wall installations.

### DETAILED DESCRIPTION OF DRAWINGS

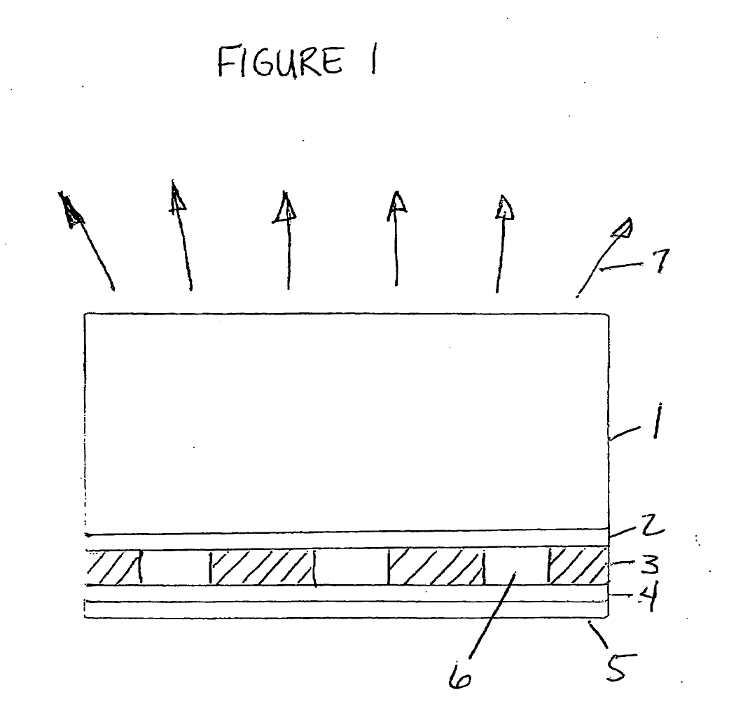

FIG. 1 depicts a lambertian directional panel light source, which consists of a solid wavelength conversion element 1 on a solid state light source 6. The light source 6 may be light emitting diode with an active region of a pn junction, single quantum well, multiple quantum wells, single heterojunction or double heterojunction; an organic light emitting diode, an inorganic light emitting diode, an edge emitter light emitting diode, a vertical cavity surface emitting laser, or a laser diode. Electrical interconnect means 2 and 4, including but not limited to, wires, transparent conductive oxides (evaporative and spin-on), thick film conductive pastes, patterned evaporative metals, and conductive epoxies, are positioned on either side of the solid state light source 6 to drive the solid state light source 6 to emit light. The wavelength conversion element 1 is on one surface of the solid state light source 6. A substantially reflective layer 5 covers the opposite surface of the solid state light source 6 from the wavelength conversion element 1. The light source 6 is shown as multiple elements and the total emitting area of these elements is much less than the cross-sectional area of the wavelength conversion element 1 to which the light source elements 6 are mounted.

The wavelength conversion element is formed from wavelength conversion materials. The wavelength conversion materials absorb light in a first wavelength range and emit light in a second wavelength range, where the light of a second wavelength range has longer wavelengths than the light of a first wavelength range. The wavelength conversion materials may be, for example, phosphor materials or quantum dot materials. The wavelength conversion element may be formed from two or more different wavelength conversion materials. The wavelength conversion element may also include optically inert host materials for the wavelength conversion materials of phosphors or quantum dots. Any optically inert host material must be transparent to ultraviolet and visible light.

Phosphor materials are typically optical inorganic materials doped with ions of lanthanide (rare earth) elements or, alternatively, ions such as chromium, titanium, vanadium, cobalt or neodymium. The lanthanide elements are lanthanum, cerium, praseodymium, neodymium, promethium, samarium, europium, gadolinium, terbium, dysprosium, holmium, erbium, thulium, ytterbium and lutetium. Optical inorganic materials include, but are not limited to, sapphire (Al.sub.2O.sub.3), gallium arsenide (GaAs), beryllium aluminum oxide (BeAl.sub.2O.sub.4), magnesium fluoride (MgF.sub.2), indium phosphide (InP), gallium phosphide (GaP), yttrium aluminum garnet (YAG or Y.sub.3Al.sub.5O.sub.12), terbium-containing garnet, yttrium-aluminum-lanthanide oxide compounds, yttrium-aluminum-lanthanide-gallium oxide compounds, yttrium oxide (Y.sub.2O.sub.3), calcium or strontium or barium halophosphates (Ca,Sr,Ba).sub.5(PO.sub.4).sub.3(Cl,F), the compound CeMgAl.sub.11O.sub.19, lanthanum phosphate (LaPO.sub.4), lanthanide pentaborate materials ((lanthanide)(Mg,Zn)B.sub.5O.sub.10), the compound BaMgAl.sub.10O.sub.17, the compound SrGa.sub.p2S.sub.4, the compounds (Sr,Mg,Ca,Ba)(Ga,Al,In).sub.2S.sub.4, the compound SrS, the compound ZnS and nitridosilicate. There are several exemplary phosphors that can be excited at 250 nm or thereabouts. An exemplary red emitting phosphor is Y.sub.2O.sub.3:Eu.sup.33+. An exemplary yellow emitting phosphor is YAG:Ce.sup.3+. Exemplary green emitting phosphors include CeMgAl.sub.11O.sub.19:Tb.sup.3+, ((lanthanide)PO.sub.4:Ce.sup.3+,Tb.sup.3+) and GdMgB.sub.5O.sub.10:Ce.sup.3+,Tb.sup.3+. Exemplary blue emitting phosphors are BaMgAl.sub.10O.sub.17:Eu.sup.2+ and (Sr,Ba,Ca).sub.5(PO.sub.4).sub.3Cl:Eu.sup.2+. For longer wavelength LED excitation in the 400-450 nm wavelength region or thereabouts, exemplary optical inorganic materials include yttrium aluminum garnet (YAG or Y.sub.3Al.sub.5O.sub.12), terbium-containing garnet, yttrium oxide (Y.sub.2O.sub.3), YVO.sub.4, SrGa.sub.2S.sub.4, (Sr,Mg,Ca,Ba)(Ga,Al,In).sub.2S.sub.4, SrS, and nitridosilicate. Exemplary phosphors for LED excitation in the 400-450 nm wavelength region include YAG:Ce.sup.3+, YAG:Ho.sup.3+, YAG:Pr.sup.3+, YAG:Tb.sup.3+, YAG:Cr.sup.3+, YAG:Cr.sup.4+, SrGa.sub.2S.sub.4:Eu.sup.2+, SrGa.sub.2S.sub.4:Ce.sup.3+, SrS:Eu.sup.2+ and nitridosilicates doped with Eu.sup.2+.

Luminescent materials based on ZnO and its alloys with Mg, Cd, Al are preferred. More preferred are doped luminescent materials of ZnO and its alloys with Mg, Cd, Al which contain rare earths, Bi, Li, Zn, as well as other luminescent dopants. Even more preferred is the use of luminescent elements which are also electrically conductive, such a rare earth doped AlZnO, InZnO, GaZnO, InGaZnO, and other transparent conductive oxides of indium, tin, zinc, cadmium, aluminum, and gallium. The use of these transparent conductive oxides, oxynitrides and nitrides which are also luminescent as both interconnect means and/or wavelength conversion means is also an embodiment of this invention. Other phosphor materials not listed here are also within the scope of this invention.

Quantum dot materials are small particles of inorganic semiconductors having particle sizes less than about 30 nanometers. Exemplary quantum dot materials include, but are not limited to, small particles of CdS, CdSe, ZnSe, InAs, GaAs and GaN. Quantum dot materials can absorb light at first wavelength and then emit light at a second wavelength, where the second wavelength is longer than the first wavelength. The wavelength of the emitted light depends on the particle size, the particle surface properties, and the inorganic semiconductor material.

The transparent and optically inert host materials are especially useful to spatially separate quantum dots. Host materials include polymer materials and inorganic materials. The polymer materials include, but are not limited to, acrylates, polystyrene, polycarbonate, fluoroacrylates, chlorofluoroacrylates, perfluoroacrylates, fluorophosphinate polymers, fluorinated polyimides, polytetrafluoroethylene, fluorosilicones, sol-gels, epoxies, thermoplastics, thermosetting plastics and silicones. Fluorinated polymers are especially useful at ultraviolet wavelengths less than 400 nanometers and infrared wavelengths greater than 700 nanometers owing to their low light absorption in those wavelength ranges. Exemplary inorganic materials include, but are not limited to, silicon dioxide, optical glasses and chalcogenide glasses.

The solid state light source is typically a light emitting diode. Light emitting diodes (LEDs) can be fabricated by epitaxially growing multiple layers of semiconductors on a growth substrate. Inorganic light-emitting diodes can be fabricated from GaN-based semiconductor materials containing gallium nitride (GaN), aluminum nitride (AlN), aluminum gallium nitride (AlGaN), indium nitride (InN), indium gallium nitride (InGaN) and aluminum indium gallium nitride (AlInGaN). Other appropriate materials for LEDs include, for example, aluminum gallium indium phosphide (AlGaInP), gallium arsenide (GaAs), indium gallium arsenide (InGaAs), indium gallium arsenide phosphide (InGaAsP), diamond or zinc oxide (ZnO).

Especially important LEDs for this invention are GaN-based LEDs that emit light in the ultraviolet, blue, cyan and green regions of the optical spectrum. The growth substrate for GaN-based LEDs is typically sapphire (Al.sub.2O.sub.3), silicon carbide (SiC), bulk gallium nitride or bulk aluminum nitride.

A solid state light source can be a blue or ultraviolet emitting LED used in conjunction with one or more wavelength conversion materials such as phosphors or quantum dots that convert at least some of the blue or ultraviolet light to other wavelengths. For example, combining a yellow phosphor with a blue emitting LED can result in a white light source. The yellow phosphor converts a portion of the blue light into yellow light. Another portion of the blue light bypasses the yellow phosphor. The combination of blue and yellow light appears white to the human eye. Alternatively, combining a green phosphor and a red phosphor with a blue LED can also form a white light source. The green phosphor converts a first portion of the blue light into green light. The red phosphor converts a second portion of the blue light into green light. A third portion of the blue light bypasses the green and red phosphors. The combination of blue, green and red light appears white to the human eye. A third way to produce a white light source is to combine blue, green and red phosphors with an ultraviolet LED. The blue, green and red phosphors convert portions of the ultraviolet light into, respectively, blue, green and red light. The combination of the blue, green and red light appears white to the human eye.

A power source (not shown) supplies current through the electrical interconnect means 2 and 4 to the solid state light source 6, which emits light of a first wavelength. Electrical interconnect means 2 and 4 are transmissive to light of the first wavelength emitted by the solid state light source 6. The first wavelength light will be emitted through the electrical interconnect means 2 and then through the wavelength conversion element 1; or through the electrical interconnect means 4, reflected from the reflective layer 5, through the solid state light source 6, through the electrical interconnect means 2 through and then through the wavelength conversion element 1. The wavelength conversion element 1 will convert some of the light of a first wavelength into light of a second wavelength. The second wavelength is different from the first wavelength. The light of the second wavelength will be transmitted out of the wavelength conversion element 1. The remainder of the unconverted light of the first wavelength will also be transmitted out of the wavelength conversion element 1 with the light of the second wavelength. The combination of light of the first wavelength with light of the second wavelength provides a broader emission spectrum of light from the combination of a solid state light source 6 and a solid wavelength conversion element 1. The combination light is lambertian and directional from the panel light source.

Electrical interconnect means 6 is positioned between the solid state light source 6 and the solid wavelength conversion element 1. Alternately, the solid wavelength conversion element 1 may be electrically conductive and able to deliver current to the solid state light source 6.

The solid state light source 6 may be a plurality of solid state light sources. This plurality of solid state light sources can be arranged co-planar or vertically for the panel light source. A single solid wavelength conversion element 1 or a plurality of solid wavelength conversion elements can be used with the plurality of solid state light sources.

A barrier layer 3 may be used between and parallel to the plurality of solid state light sources between the electrical interconnect means 2 and 4 to isolate interconnect means 2 and 4. This barrier layer 3 may be used to form environmental and electrically insulative protection for the solid state light sources 6. The barrier layer includes, but is not limited to, sol-gels, glasses, epoxies and frits.

Spectrum, angular, and polarization means such as dichroic films, microoptics, and reflective polarizers, either on or in proximity to the panel light source, may modify the output distribution of the panel light source of FIG. 1.

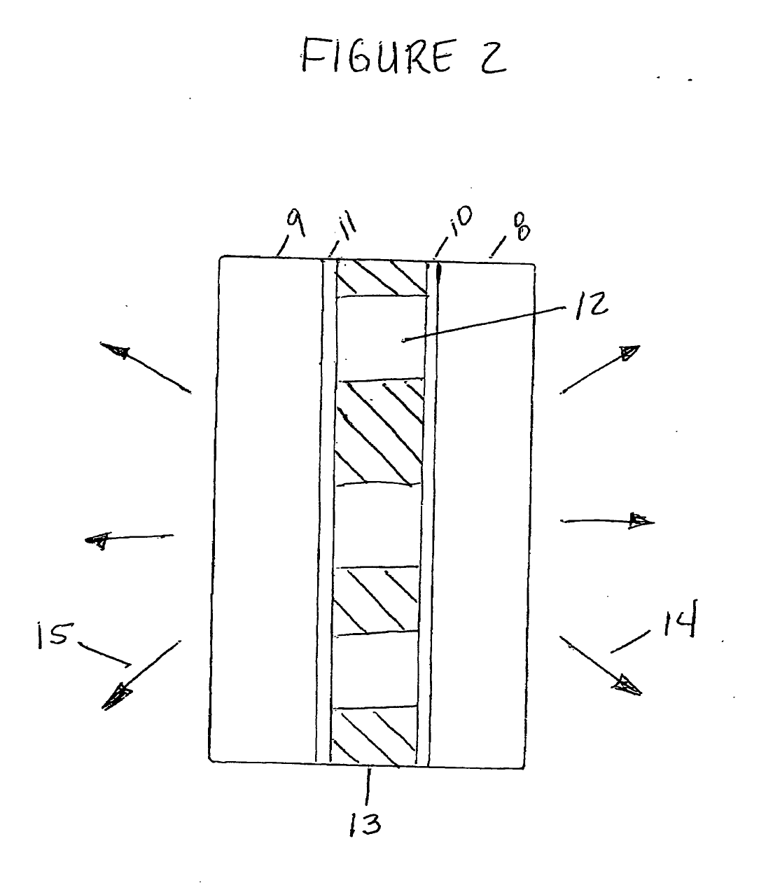

FIG. 2 depicts a substantially isotropic panel light source which consists of a solid state light source 12 between two solid wavelength conversion elements 8 and 9. The substantially isotropic panel light source has a first solid wavelength conversion element 8, a first electrical interconnect means 10, a solid state light source 12, a second electrical interconnect means 11, and a second solid wavelength conversion element 9. The first solid wavelength conversion element 8 and the second solid wavelength conversion element 10 are formed of the same wavelength conversion material and both convert light of a first wavelength onto light of the same second wavelength. As in the FIG. 1 structure, the light source 12 in FIG. 2 is shown as multiple elements and the total emitting area of these elements is much less than the cross-sectional area of either of the wavelength conversion elements 8 and 9 between which the light source elements 12 are mounted.

A power source (not shown) supplies current through the electrical interconnect means 10 and 11 to the solid state light source 12, which emits light of a first wavelength. Electrical interconnect means 10 and 11 are transmissive to light of the first wavelength emitted by the solid state light source 12.

The first wavelength light will be emitted from the solid state light source 12 through the electrical interconnect means 10 to the wavelength conversion element 9. The first wavelength light will also be emitted from the solid state light source 12 through the electrical interconnect means 10 to the wavelength conversion element 8. Light 15 and 14 is emitted from both sides of the planar light source of FIG. 2.

The first wavelength light will be emitted from the solid state light source 12 through the electrical interconnect means 11 to the wavelength conversion element 9. The wavelength conversion element 9 will convert some of the light of a first wavelength into light of a second wavelength. The second wavelength is different from the first wavelength. The light of the second wavelength will be transmitted out of the wavelength conversion element 9. The remainder of the unconverted light of the first wavelength will also be transmitted out of the wavelength conversion element 9 with the light of the second wavelength. The combination of light of the first wavelength with light of the second wavelength provides a broader emission spectrum of light 15 from the combination of a solid state light source 12 and a solid wavelength conversion element 9.

At the same time, the first wavelength light will be emitted from the solid state light source 12 through the electrical interconnect means 10 to the wavelength conversion element 8. The wavelength conversion element 8 will convert some of the light of a first wavelength into light of a second wavelength. The second wavelength is different from the first wavelength. The light of the second wavelength will be transmitted out of the wavelength conversion element 8. The remainder of the unconverted light of the first wavelength will also be transmitted out of the wavelength conversion element 9 with the light of the second wavelength. The combination of light of the first wavelength with light of the second wavelength provides a broader emission spectrum of light 14 from the combination of a solid state light source 12 and a solid wavelength conversion element 8.

Light is emitted from both sides of the planar light source of FIG. 2. The combination light from both sides of the planar light source is substantially isotropic from the panel light source. If the output from each side is lambertian, then the light source is an isotropic emitter. If a dichroic, microoptic, polarizer, or photonic crystal structure is added to the luminescent element, the light source will be a directional emitter from one or both sides.

The solid state light source 12 may be a plurality of solid state light sources. This plurality of solid state light sources can be arranged co-planar or vertically for the panel light source. A single solid wavelength conversion element 9 or 8 or a plurality of solid wavelength conversion elements can be used with the plurality of solid state light sources.

A barrier layer 13 may be used between and parallel to the plurality of solid state light sources between the electrical interconnect means 11 and 10 to isolate interconnect means 11 and 10. This barrier layer 13 may be used to form environmental and electrically insulative protection for the solid state light sources 12. The barrier layer includes, but is not limited to, sol-gels, glasses, epoxies and frits.

As in FIG. 1, intrinsically electrically conductive solid wavelength conversion elements 8 and/or 9 of FIG. 2 may be used alternately, or in combination with one or both of interconnect means 10 and/or 11, to deliver power to solid state lighting source 12. The use of freestanding epitaxial chips, which emit substantially isotropical light, are a preferred solid state light source.

Spectrum, angular, and polarization means such as dichroic films, microoptics, and reflective polarizers, either on or in proximity to the panel light source, may modify the output distribution of the panel light source of FIG. 2.

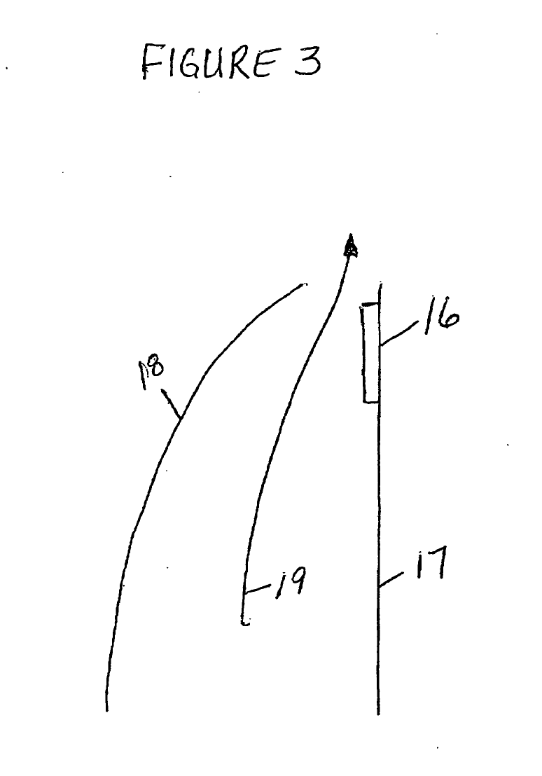

FIG. 3 depicts a lighting fixture that reflects and directs the light from a directional panel light source 16 substantially down a vertical surface 17 to form a wall washing effect. The directional panel light 16 is positioned on the vertical surface 17. A curved reflector 18 is spaced from the directional panel light 16 and the vertical surface 17, starting roughly parallel to the directional panel light 16 and curving outward and down from the directional panel light source. The curved reflector will reflect and direct light emitted from the directional panel light source down the vertical surface. The vertical surface 17 can be a mount or a wall. The curved reflector can be supported by the vertical surface.

Airflow 19 is between the vertical surface 17 and the curved reflector 16 past the directional light source 16 and exits through at least one opening in reflector 18. The airflow is via induced draft effects created by the heat generated by the directional light source 16 and the induced draft structure created by vertical surface 17 and curved reflector 16. The airflow cools the directional light source 16. Fixture design creates induced draft cooling channels around or in proximity to the panel light The thermally conductive luminescent element not only converts at least a portion of the light emitted from the solid state light source into a broader emission spectrum, but it also serves to diffuse/distribute the light generated as well as provide a cooling path for itself and the solid state light source to the surrounding ambient via convection off the surface of the thermally conductive luminescent element.

Baffling can be optionally used to prevent light leakage through the opening in the curved reflector 18. Also alternately, the directional panel light source 16 can emit a portion of light through the opening in the curved reflector 18 to provide up lighting.

Optionally, thermal conduction and additional cooling means, such as thermoelectric coolers, heatsinks and heat pipes, can be added to directional panel light source 16 to further cool the directional panel light 16.

Alternately, the curved reflector can extend upward to direct the light from the light source in an up direction to form a wall washing effect. Also, alternately, the reflector can be straight or another geometric shape or non-geometric shape. The only requirement is that the reflector be angled away from the directional panel light source on the vertical surface of the wall or mount.

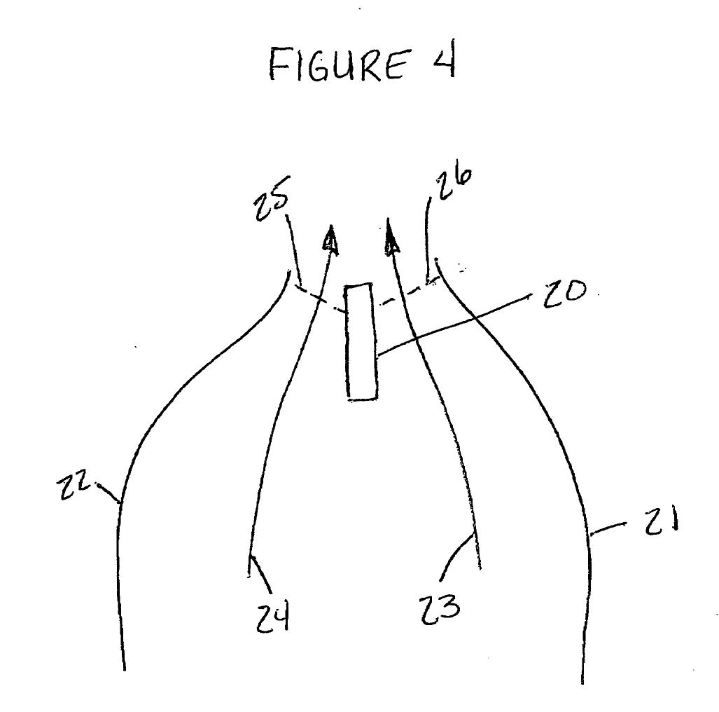

FIG. 4 depicts a light fixture having a substantially isotropic panel light source 20 between two reflectors 21 and 22. A first support member 25 supports and separates the first reflector 22 from the isotropic panel light source 20. A second support member 26 supports and separates the isotropic panel light source 20 from a second reflector 21. The first and second reflectors are curved reflectors, which curve down and outward from the light source. The curves of the first and second reflectors are opposite and mirror images of the other. Reflectors 21 and 22 form a trough reflector for the light emitted by substantially isotropic panel light source 20 to be reflected and directed downward.

Reflectors 21 and 22 also form a cooling means allowing airflow 24 and 23. Airflow 24 is adjacent to the curved first reflector 22 past the isotropic light source 20 and exits past the first support member 25. Airflow 23 is adjacent to the curved second reflector 21 past the isotropic light source 20 and exits past the second support member 26. The airflow 24 and 23 are via induced draft effects created by the heat generated by the directional light fixture 21 and the control of airflow by curved first reflector 22 and curved second reflector 21. As known in the art, induced draft cooling structures can be used to increase the convective cooling coefficient on a heated surface by over an order of magnitude. This approach has typically been used in electronic enclosures such as computer cabinets where a fan is not desired. The proper design of curved first reflector 22 and curved second reflector 21 can allow for enhanced cooling of isotropic light source 20 as well as be used as a reflector of the light generated by isotropic light source 20. The airflow cools the isotropic light source 20 on both sides.

Again, baffling can be optionally used to prevent light leakage through the first and second support members 25 and 26. Also alternately, the isotropic panel light source 20 can emit a portion of light past the first and second support members 25 and 26 to provide up lighting.

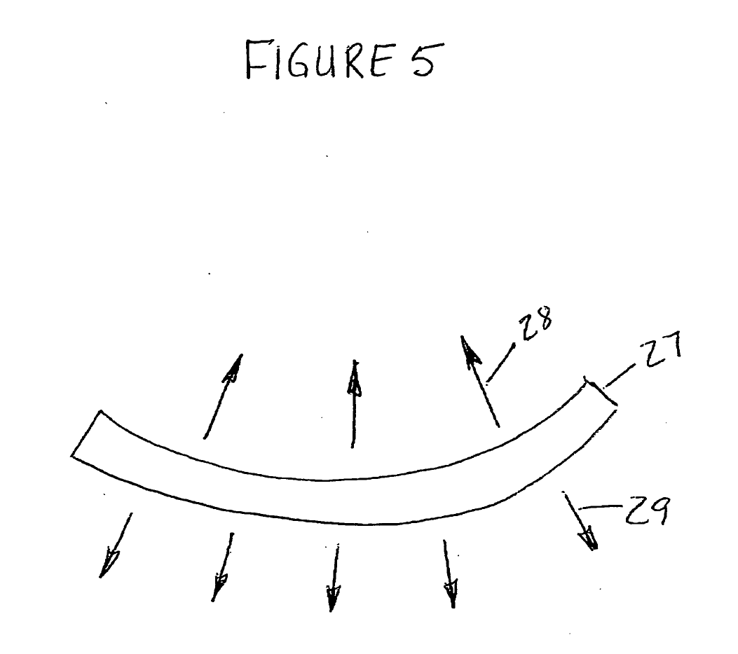

FIG. 5 depicts a curved panel light source 27 for a light fixture. Light 28 may be emitted on the concave curve of the panel light source 27 and/or light 29 may be emitted on the convex curve of the panel light source 27. Light 28 and 29 may be emitted from both sides of the panel light source 27. The panel light source 27 may be lambertian or isotropic. Ceramic and glass based thermally conductive luminescent elements can be easily manufactured in a non-flat shape for curved panel light source 27.

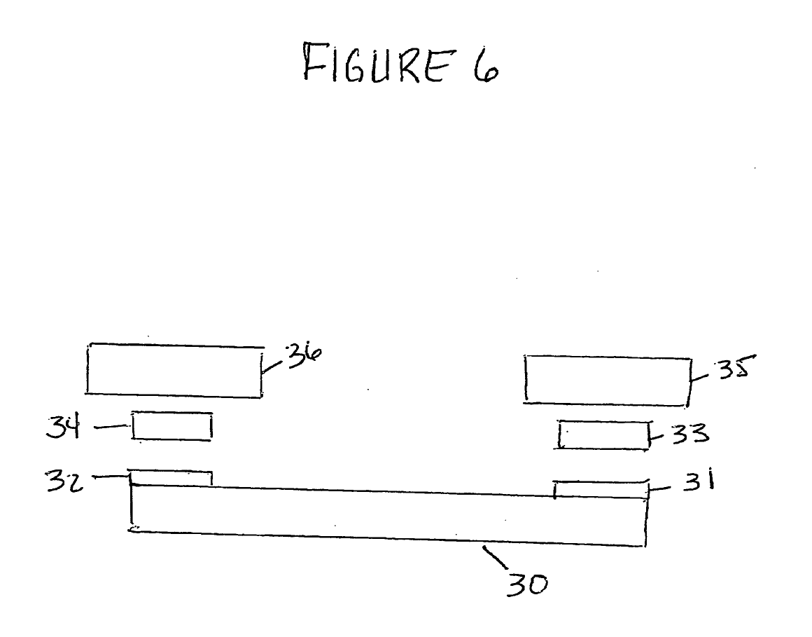

FIG. 6 depicts the use of magnetic elements 36 and 35 to make electrical connection between fixture contacts 33 and 34 and light source contacts 31 and 32 on panel light source 30 for a light fixture. Fixture contacts 33 and 34 are stationary and fixed in position. Light source contacts 31 and 32 and attached panel light source 30 are movable. The panel light source 30 has a small mass and rigid construction. First magnetic element 36 will attract first light source contact 32 until the first light source contact 32 makes physical contact with first fixture contact 34 and stops, remaining in physical contact and electrical connection with first fixture contact 34. Second magnetic element 35 will attract second light source contact 31 until the second light source contact 31 makes physical contact with second fixture contact 33 and stops, remaining in physical contact and electrical connection with second fixture contact 33. The first and second magnetic elements 36 and 35 serve to hold the panel light source in position and hold the light source contacts 32 and 31 to the fixture contacts 34 and 31.

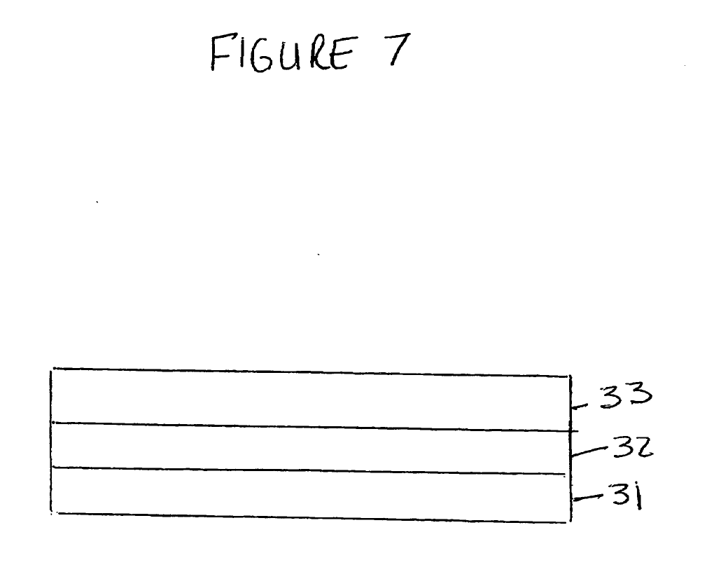

FIG. 7 depicts a panel light source 31 with an energy storage means 32 and solar cell conversion means 33 for a light fixture. Sunlight or external light will be incident upon the solar cell conversion means 33 which will convert the sunlight or external light into electricity. The solar cell conversion means 33 can be a standard silicon-based solar cell. The electricity will flow from the solar cell conversion means 33 to the adjacent energy storage means 32. The energy storage means 32, such as a battery or capacitor will store the electricity. The electricity will flow from the energy storage means 32 to the adjacent panel light source 31 which will emit light. The rigid nature of the thermally conductive luminescent element within the panel light source 31 provides support and cooling means for both the energy storage means 32 and solar conversion element 33. Using this configuration, a panel light source can be constructed which does not required any external power input other than incident solar energy.

Power conditioning and power converting means enable direct connection to residential and commercial DC, pulsed, or AC power sources directly on the at least one thermally conductive luminescent element. In this case, the at least one thermally conductive luminescent element becomes the substrate to which the electronic components are mounted and cooled. The electronic components may be active and passive electronic devices. Thermal and light sensors can control and protect the large area panel light source. Anti-parallel interconnects between multiple solid state light sources can be used for direct AC excitation of the panel lights.

Thermally conductive structures within the fixture provide additional cooling to the panel light via attachment to edges or at least some portion of the panel light source. A number of optical designs take advantage of the direct view capability of the at least one panel light source. The size of the panel lights are based on allowable surface brightness, required surface cooling area (which is related to the amount of available airflow and/or conduction cooling), and desired total lumens of output. More preferably, isotropic and directive panel lights have surface areas greater than 1 square inch. Even more preferably, directive and isotropic panel lights with surface brightness of between 1000 and 10000 ftl have surface areas greater than 1 sq inch.

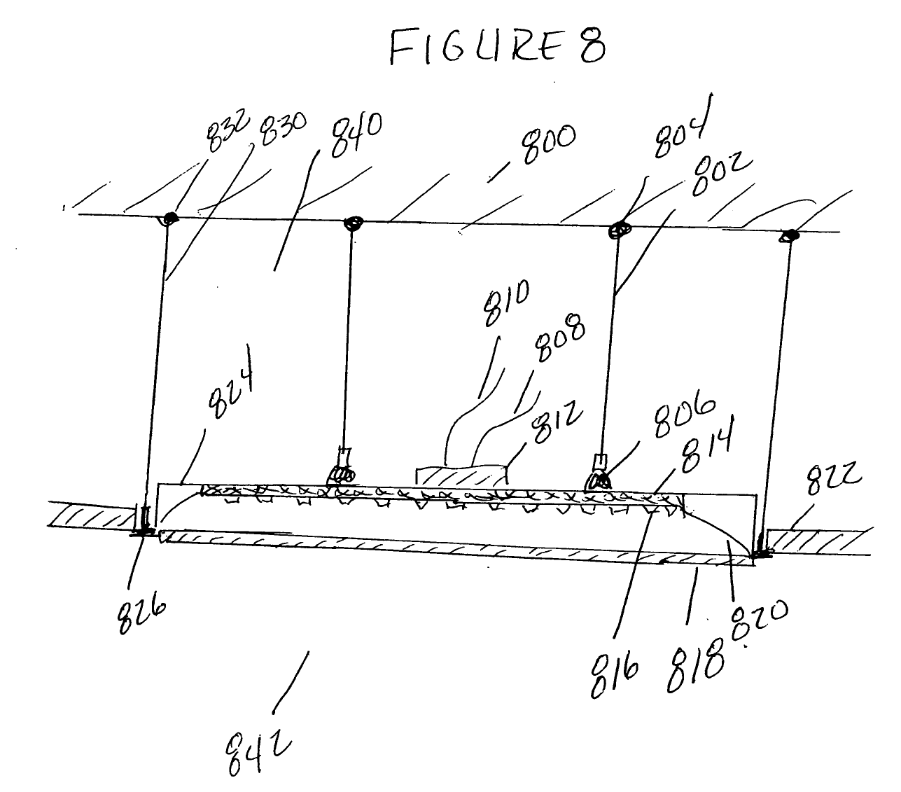

FIG. 8 is a side view of a prior art solid state troffer mounted in a T grid suspended ceiling. Troffers are typically 2 foot×2 foot or 2 foot by 4 foot lighting fixtures for fluorescent or more recently LED linear arrays. The issue is that troffers distract from the ceiling aesthetics and limit architects and designers. The amount of acoustical damping and the amount of thermal insulation is also limited. In addition, troffers are typically several inches thick consisting of steel box 824, reflectors 820, diffusers 818, linear light sources 814 (fluorescent or linear arrays of LEDs 816), and drivers 812. The driver is connected to the building AC power typically via power cables 808 and 810. The volume of these light fixtures leads to increased shipping and stock costs. Also, the weight and size of the fixtures mandate that separate suspension lines 802 and mechanical fasteners 806 and 804 must be used all the way up to the deck 800 instead of being supported by the suspended ceiling. This is mandated by federal seismic building code standards. As such, the grid support wires 830 and anchors 832 which support the grid 826 and ceiling tiles 822 are not used to support these conventional lighting fixtures. This restriction could be overcome if a lightweight self cooling light source could be integrated into the grid 826 and/or ceiling tiles 822. In addition, conventional solid state lighting fixtures typically require back side cooling such that the heat generated in the linear light sources 814 must dissipate the majority of it's heat into the space 840 between the deck 800 and suspended ceiling tiles 822. In many cases, this volume has limited air flow or may even be thermally insulated. Most commercial solid state troffers must have their output derated for these situations due to higher operating temperatures. In a typical installation the troffers occupy 10 to 20% of the surface of the suspended ceiling. 15/16 grid and 9/16 grid 826 represent similar surface area coverage. As such the grid 826 if it emitted similar surface brightness would eliminate the need for troffers all together in suspended ceiling applications. Such a light emitting grid requires light sources that are self-cooling and light weight. This is accomplished in this invention. The use of grids 826 which contain low voltage DC eliminates the need for drivers 812 and separate power cables 808 and 810. The integration of self-cooling light source into a DC grid can also allow for adaptability when the self-cooling light source can not only be electrically connect to the DC grid but also can mechanically be connected to grid 826 from the office space 842 with sufficient mechanical integrity such that seismic requirements can be met. The embodiments disclosed below address the need for light sources which can be integrated into the grid 826 and/or ceiling tiles from the office space 842 and can be substantially cooled, installed, removed, repositioned from the office side of the installation (the underside of the ceiling panel.

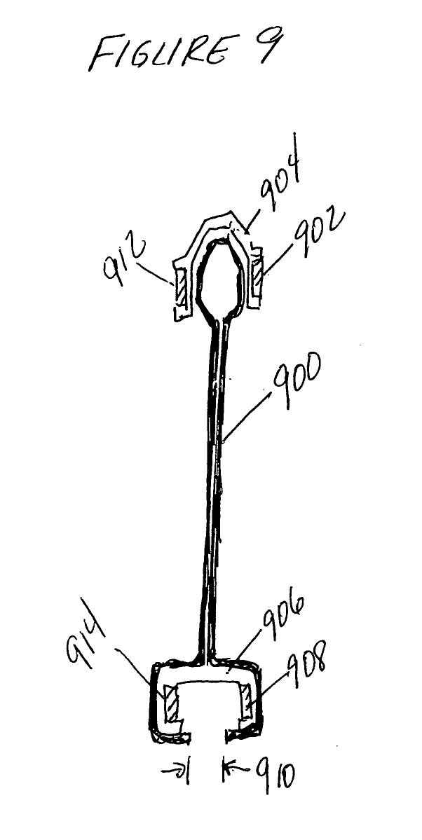

FIG. 9 is a side view of a prior art DC T grid. The steel or metal grid 900 typically is formed as shown. Alternate shapes and conductor mountings are possible and anticipated herein. Top conductors 902 and 912 are embedded in dielectric 904 for electric connections to fixtures and devices which connect between the ceiling tiles and the deck. Bottom conductors 908 and 914 embedded in dielectric 906 for connection that occur from the office side of the installation. Mechanical support and electrical contact for office space mounted devices typically would occur through opening 910.

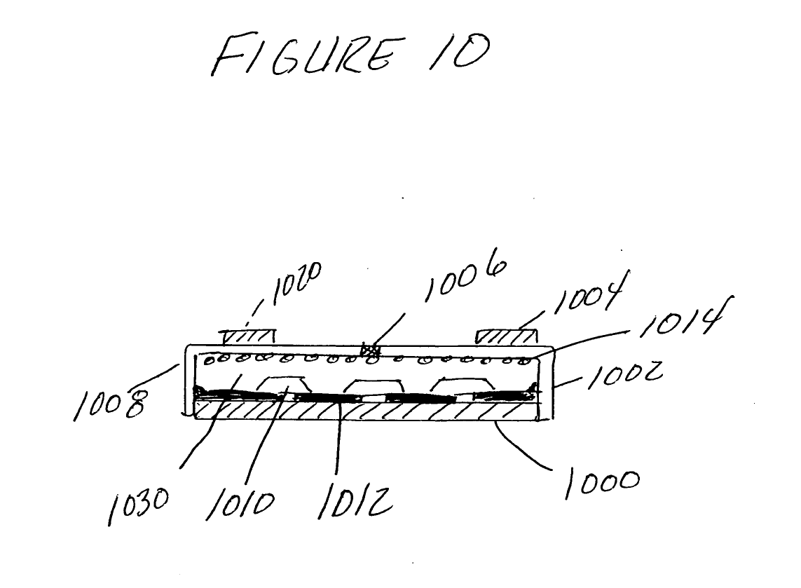

FIG. 10 is a side view of a suspended ceiling panel light of the present invention. It is possible to construct solid state light sources in which the light emitting surface and the cooling surface are substantially the same surface area. In this figure, translucent thermally conductive element 1000 functions both as a light emitting surface and as a cooling surface for the LEDs 1010. Also unique is the LED(s) 1010 is (are) bonded to an interconnect 1012 on the translucent thermally conductive element 1000. The interconnect 1012 may be bonded, placed on, mounted to or other means to provide electrical connection between LEDs 1010. Alternately, interconnect 1012 may be a patterned TCO including but not limited to ZnO, ITO, GIZO, nanowires, and other transparent conductive layers. Direct attach blue LEDs 1010 are shown with wavelength conversion occurring in powder layer 1014 on reflectors 1002 and 1008. The two reflectors 1002 and 1008 were electrically isolated by dielectric barrier 1006 such that interconnect 1012 can be connected to reflectors 1008 and 1002 and reflectors 1008 and 1002 can be used as both optical elements and electrical elements as shown. Contacts 1020 and 1004 are connected to reflector 1008 and 1002 respectively and can be in the form of pins, clips, magnets, conductive adhesives or other mechanical means to electrically and mechanically connect to the grid (not shown).

In this particular embodiment the light emitted by direct attach blue LEDs 1010 may emit into air or a transparent dielectric waveguide. Translucent thermally conductive element 1000 may or may not contain luminescent elements as disclosed in the cited relevant art. Most preferably the thermal conductivity of the translucent thermally conductive element 1000 is greater than 0.3 W/m/K and even more preferably greater than 1.0 W/m/K. As will be disclosed later, the thermal conductivity of the translucent thermally conductive element 1000 determines the maximum surface brightness attainable per unit area of light source which can be cooled from the office space side while maintaining a light source surface temperature within reasonable limits.

The thickness also plays a role in how far the heat generated by the LEDs is spread over the surface of the source. The goal is to make light panels which are less than 10 mm thick and even more preferably less than 5 mm thick and most preferably less than 2 mm thick. As such higher thermal conductivity materials or composites are preferred to maintain reasonable source thicknesses.

It should be noted that layered and composites can be used to create an average thermal conductivity greater than 0.3 W/m/K. Touch temperatures should not exceed 80 C and more preferably are below 50 C. In addition, the thermal conductivity of the translucent thermally conductive element 1000 determines how well the heat generated by the direct die attach blue LEDs 1010 is spread out over the surface area of light source. Natural convection cooling is directly proportional to the natural convection cooling coefficient h (typically between 3 and 25 W/2/K), the effective surface area, and the temperature difference between the ambient and the light source surface. It should be noted that if translucent thermally conductive element 1000 has a thermal conductivity too low the effective surface area is dramatically reduced which then dramatically reduces amount of heat which can be dissipated using this approach. This sets limits on the materials which can be used for translucent thermally conductive element 1000.

From a weight standpoint, organic materials like polymers would be ideally suited for this application. Polymers however have thermal conductivities between 0.1 and 0.3 W/m/K. For very low brightness level sources it is possible to use polymers in the disclosed approach, however organics filled with thermally conductive translucent fillers such as hexagonal boron nitride, diamond, etc. which increase the thermal conductivity of translucent thermally conductive element 1000 to greater than 0.3 W/m/K are more preferred. An exception to this is highly aligned organics which have recently been announced.

In general, translucent materials with low optical absorption within the visible region which also have thermal conductivity greater than 0.3 W/m/K are preferred. Glass also may be used. Glasses typically have thermal conductivity of approximately 1 W/m/K. Again the brightness of the sources are limited by the effective cooling area of the sources. The use of composites containing non-absorbing or translucent fillers to further increase the thermal conductivity of translucent thermally conductive element 1000 is preferred.

The interconnect 1012 may also be used to enhance thermal spreading by forming a composite translucent thermally conductive element 1000. As an example, silver ink traces may be fired to form interconnect 1012 on to a glass plate to form translucent thermally conductive element 1000. Based on reasonable coverage and thickness the silver ink traces may add substantially to the effective cooling surface area of the translucent thermally conductive element 1000. In addition to waveguide region 1030 may be a thermally conductive element such as glass and be at least partially bonded to translucent thermally conductive element 1000 to further enhance the thermal spreading. Reflectors 1008 and 1002 also may be used for additional heat spreading, however in most cases these surfaces are available for transfer of heat to the ambient of the office space. Unique to this light source and a preferred embodiment are at least one LED bonded (and interconnected) to a thermally conductive translucent element which provides the majority (over 50%) of the heat dissipation of the LEDs and panel light source. Most preferred are that no other heat sinks are required to allow for continuous operation of the light source while maintaining the LED(s) temperature within efficient operating levels.

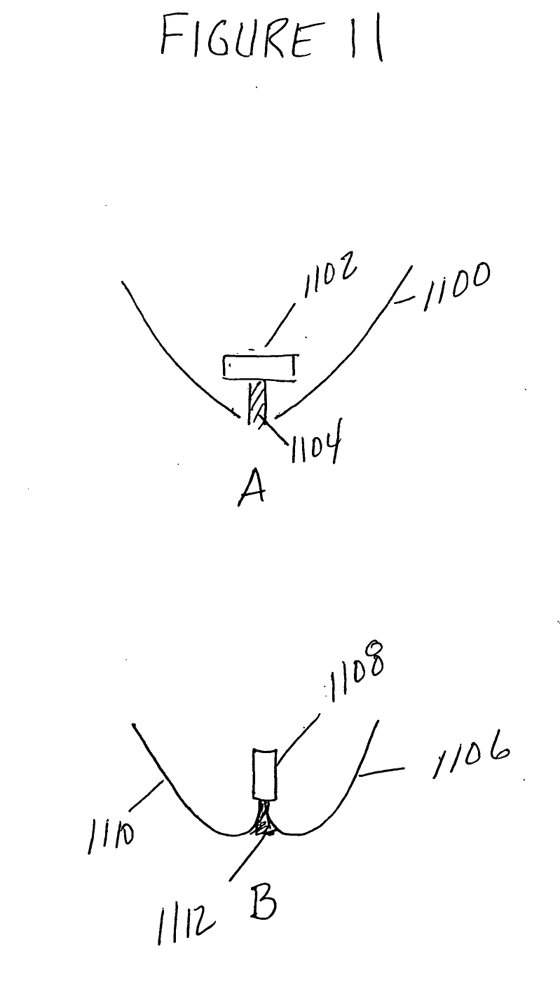

FIG. 11 is a side view of a suspended ceiling linear light containing multiple self cooling solid state light sources located near the focal point of a reflective optical element. With this invention the light source does not require additional heatsinking means which allows for a variety of reflectors and optical elements to be used. Unlike conventional solid state sources the self cooling light sources can be at or near the focal point of the reflective elements such as CPCs, ellipsoids and other directional reflective elements.

In FIG. 11A self-cooling light source 1102 is suspended within ellipsoidal reflector 1100 using connector element 1104. This not only allows for the use of lightweight reflective elements such as metal coated plastics but also allows for designs with improved high angle cut-offs to reduce glare within the office space. While only a 2D version is shown the concept can be extended to 3D and multiple sources within a single reflector as well.

FIG. 11B depicts vertically aligned self cooling light source 1108 in which electrical connections also occur using electrically conductive reflectors 1106 and 1110. Dielectric element 1112 electrically isolates reflector 1106 and 1110 from each other. Using the embodiments described herein these approaches can be integrated with the DC grid (not shown) using mechanical and electrical connectors (not shown). Because the 24 VDC is touch safe the reflectors 1106 and 1110 do not have to be electrically isolated from the office space.

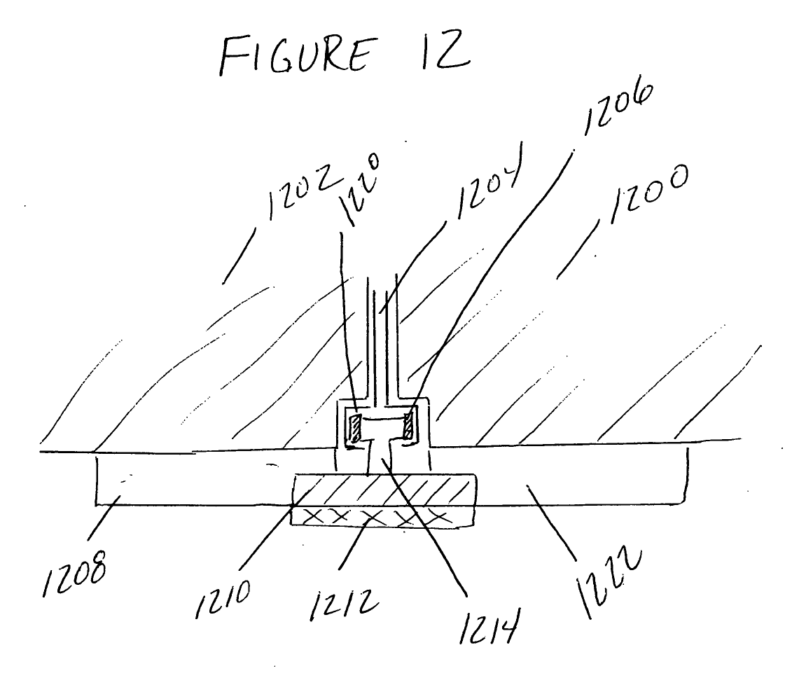

FIG. 12 is a side view of a suspended ceiling panel light with a central support member and heat transfer element. Ceiling tiles 1202 and 1200 are supported by DC grid 1204 which also contains 24 VDC contacts 1206 and 1220 which are connected to the self cooling light source 1210. In this embodiment, the light emission from self cooling light source 1210 is coupled to waveguide elements 1208 and 1222 which may or may not be attached to ceiling tile 1202 and 1200. The purpose of the waveguiding elements 1208 and 1222 is to further increase the emission area of the self cooling light source 1210. Optionally, a reflector/diffuser 1212 may be added to couple more or less light into waveguides 1208 and 1222. If the reflector/diffuser 1212 is reflective or opaque two separate light emitting areas are formed based on emission from the waveguide 1208 and 1222. Wavelength conversion may or may not occur within the waveguide elements and additional elements such as reflectors may be used to create directivity from waveguides 1208 and 1222.

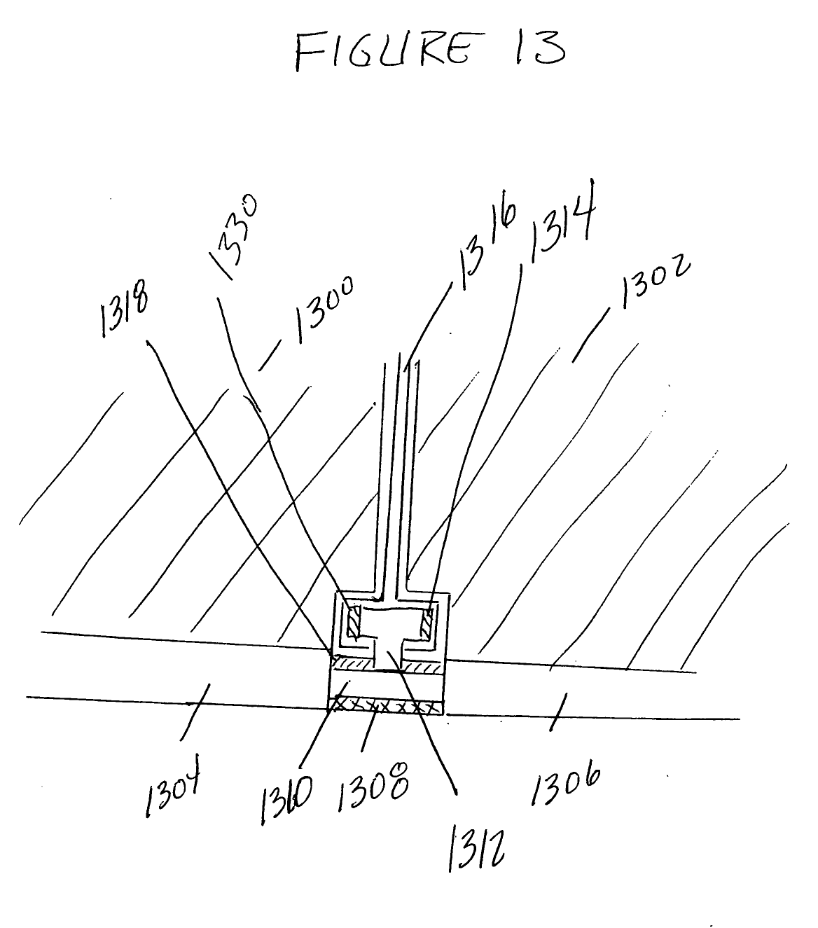

FIG. 13 is a side view of a suspended ceiling linear array with a waveguide integrated into a ceiling tile. In this embodiment the waveguide elements 1306 and 1304 are integrated into the ceiling tiles 1302 and 1300 respectively. Again, grid 1316 supports ceiling tile 1300 and 1302 and connection to self cooling light source 1310 occurs between grid contacts 1314 and 1330 using connector 1312. Additional reflectors 1318 and 1308 may be added to further direct light from self cooling light source 1310 into waveguides 1306 and 1304. A wide range of decorative elements are now possible within ceiling tile 1302 and 1300 using the light within waveguide 1304 and 1306 to illuminate the ceiling tile and features within the ceiling tiles. If 1308 is diffuser or directional element, the ratio of light emitted directly from the self cooling light source 1310 and waveguides 1306 and 1304 can be tailored. More than one self cooling light sources 1310 and/or separately controlled self cooling light sources 1310 are also disclosed.

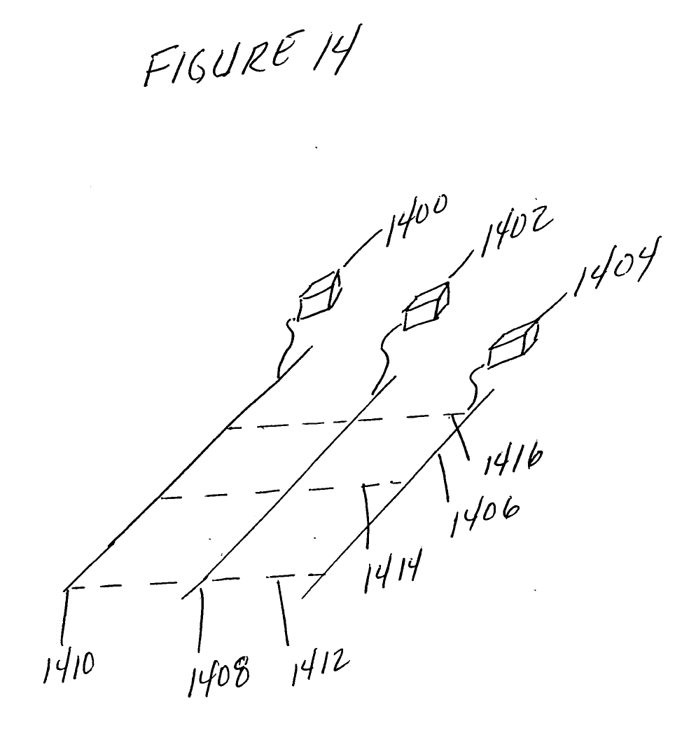

FIG. 14 is a side view of grid array with separate dimming circuits. In this embodiment, individual grid lines 1410, 1408, and 1406 are electrically isolated by cross grids 1412, 1414 and 1416. In this manner DC drivers 1404, 1402, and 1400 can modulate the self cooling light sources (not shown) connected on separate individual grid lines 1410, 1408, and 1406. In the previous example, grid line 1408 could have direct emitting self cooling lights and grid lines 1410 and 1406 could have waveguide coupled self cooling light sources. If 1410 and 1406 is energized and 1408 is not the office space or area underneath the light sources will be illuminated with waveguide based lighting only. Alternately if 1408 is energized and not 1410 and 1406 then only direct lighting is used. In like manner many combinations are then possible to customize a lighting scene.

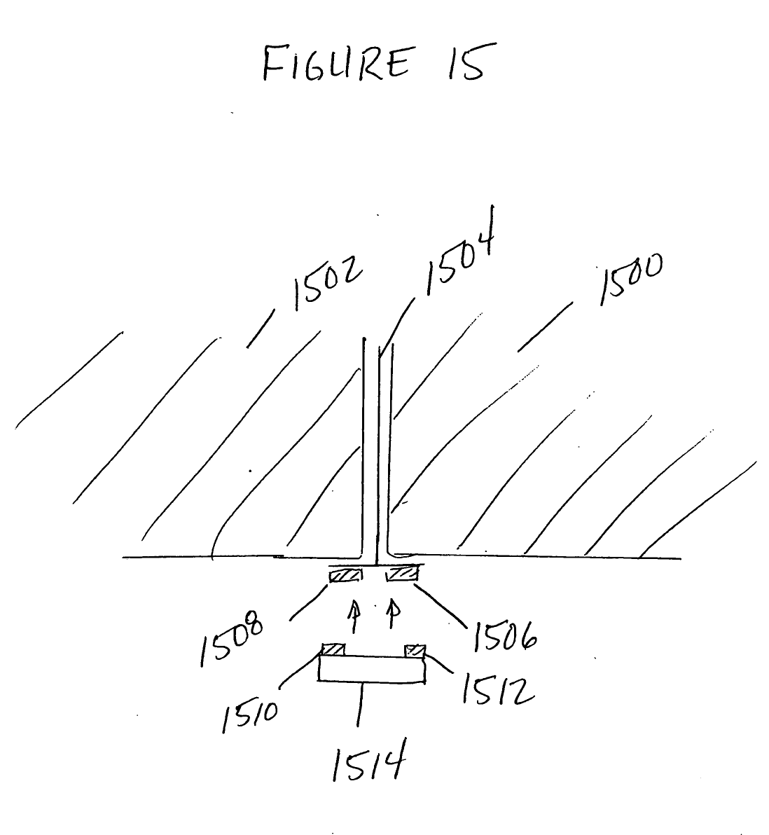

FIG. 15 is a side view of grid array with field replaceable light sources. As previously disclosed 24 VDC operation is touch safe and as such recessed conductors are not required. Grid 1504 contains to exterior conductors 1508 and 1506 which form planar contacts. Given the lightweight of self-cooling light source 1514, if grid 1504 is steel or otherwise a magnetic material, magnetic contacts 1510 and 1512 can be used to create a very low profile light source. To meet seismic regulations, the weight of self cooling light source 1514 must be very low and magnetic contacts 1510 and 1512 must provide sufficient support for self cooling light source 1514. As shown in these embodiments, the means is shown to create very lightweight self cooling light sources that will not detach by their own weight if shaken or during a seismic event.

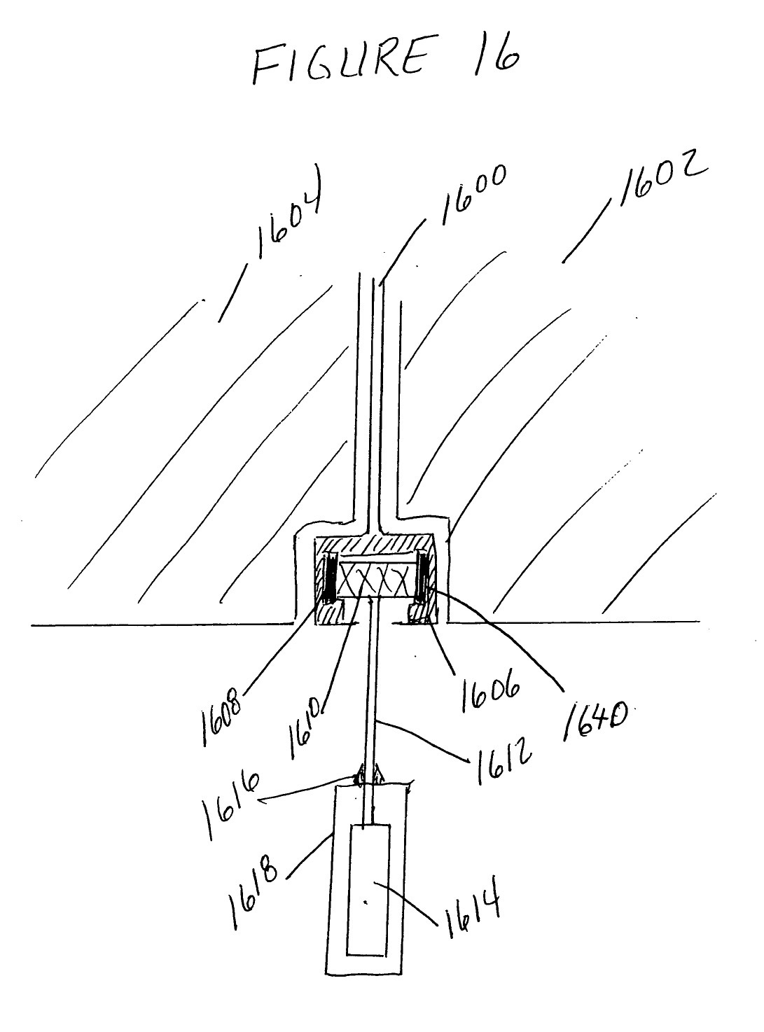

FIG. 16 is a side view of a pendant for suspended ceilings based on the self cooling light sources described herein. Grid 1600 again contains conductor 1608 and 1640 isolated from grid 1600 by dielectric 1606. Source connector 1610 electrically connects wires 1612 to self cooling light source 1614. Optionally, shade 1618 may also be supported by wires 1612 using clamp 1616. Most preferably, shade 1618 allows for airflow to self cooling light source 1614 in a manner similar to halogen or incandescent sources.

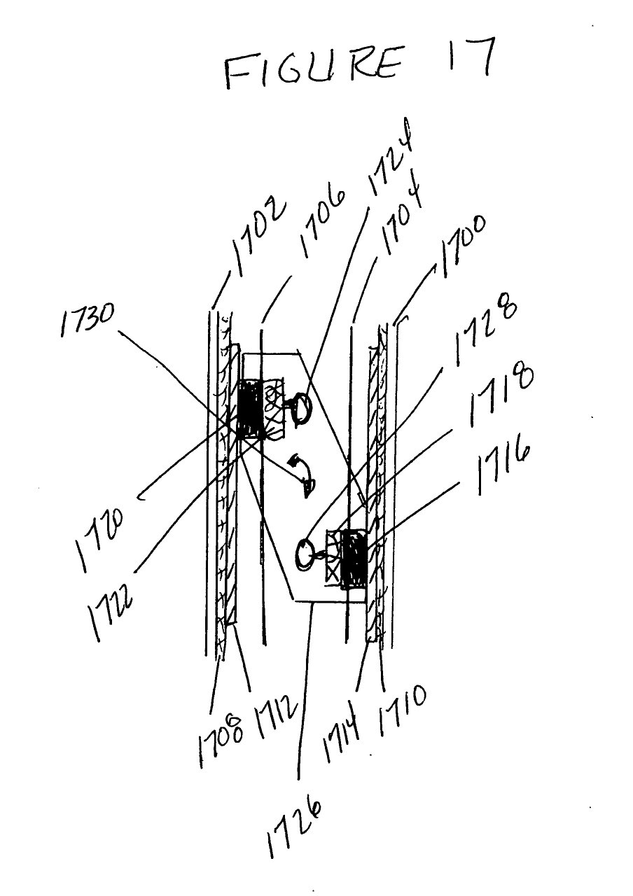

FIG. 17 is a top down view of a magnetic contact and support for grids. In this embodiment, magnets 1722 and 1718 have their field oriented such that contacts 1720 and 1716 respectively are pulled toward conductor 1712 and 1714 respectively due to the attraction to grid elements 1702 and 1700 respectively. Dielectric layer 1708 and 1710 electrically isolate conductors 1712 and 1714 from the grid elements 1702 and 1700 respectively. Support piece 1726 which contains contacts 1716, 1720, magnets 1722 and 1718, external contacts 1724 and 1728 is shaped such that if rotated slightly it will fit between slot edges 1706 and 1704. Once in the channel (side view shown in previous FIG. 16), the magnets 1720 and 1718 will cause the support piece 1726 to rotate as shown by rotation arrows 1730. In this manner a simple removable magnetic contact can be formed to the grid. The support piece 1726 once in position mechanically as shown provides additional mechanical support from the channel. The magnetic contact as depicted may be integrated into the self cooling light source (not shown) or be a separate element into which the self cooling light source (not shown) plugs, clips or otherwise electrically and/or mechanically attaches via contacts 1724 and 1726.

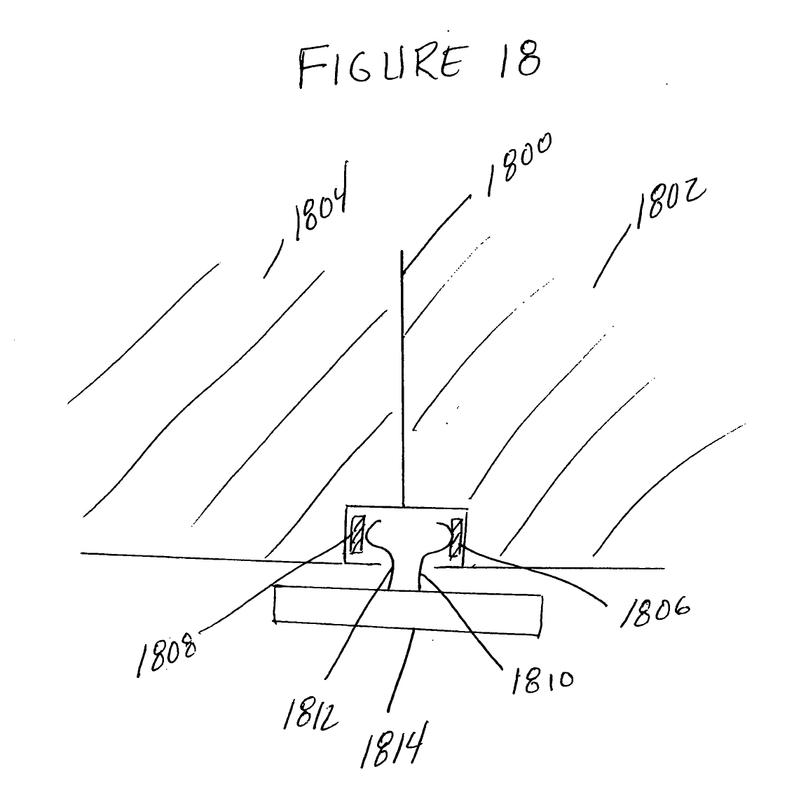

FIG. 18 is a side view of a field replaceable panel light for suspended ceilings based on spring clips 1812 and 1810. In this embodiment, grid 1800 supports ceiling tile 1802 and 1804 and contains conductors 1806 and 1808 which are connected to a DC or low voltage AC power source. Self cooling light source 1814 contains clips 1812 and 1810 which contact conductor 1808 and 1806 respectively. Additional dielectric elements on spring clips 1812 and 1810 are also possible to prevent shorting to the grid 1800.

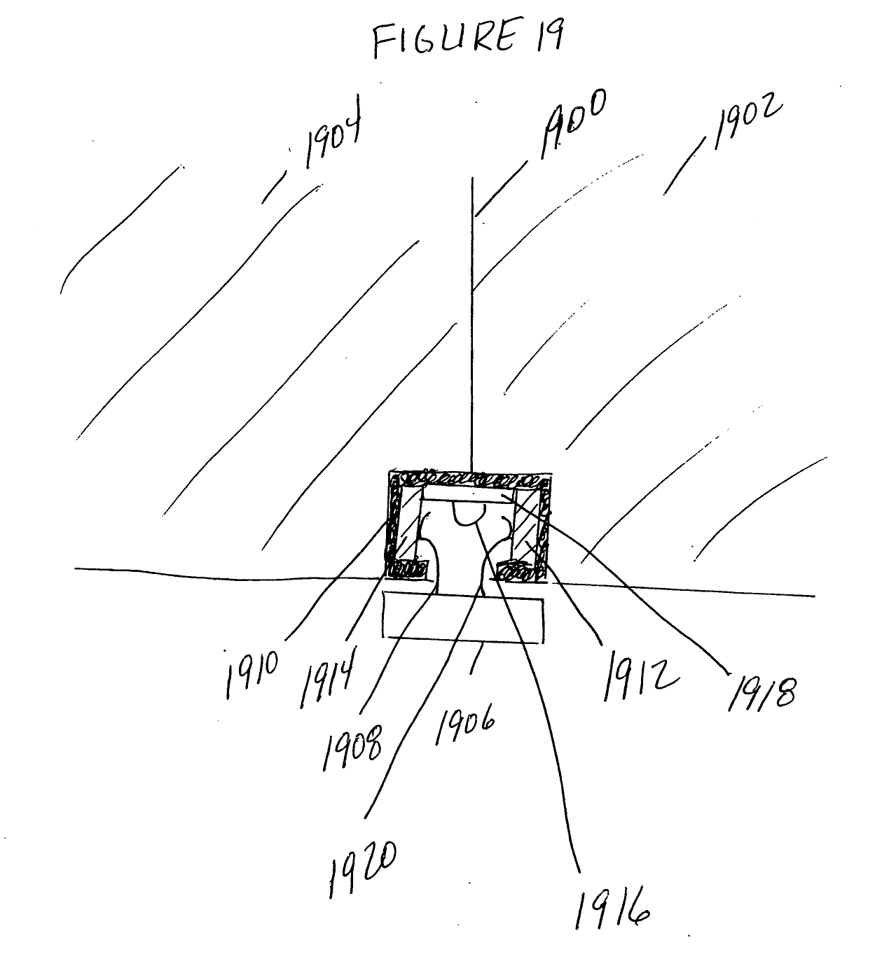

FIG. 19 is a side view of a suspended ceiling panel light with an additional integrated sensor unit for dimming, fire, occupancy, and temperature. Grid 1900 again contains a dielectric channel 1910 in which conductors 1914 and 1912 are embedded. In this embodiment, sensor/controller board 1918 is also within the channel. On sensor/controller board 1918, sensor element 1916 may be used. In the case, where self cooling light source 1906 does not contain an opaque reflector element, sensor element 1916 can “see through” self cooling light source 1906 to the office space below. Alternately, sensing elements can be incorporated into self cooling light source 1906 as previously disclosed in the referenced filings and connected to the sensor/controller board 1918. While clip contacts 1920 and 1908 are shown contacting conductors 1914 and 1912, they may alternately connect first into sensor/controller board 1918 with sensor/controller board 1918 connected to conductors 1914 and 1912. Using this approach external movement, remote dimming, color balancing, light harvesting and other techniques known in the art can be used. As an example a IR sensor (to sense occupants in the area to be illuminated) can be used for sensor element 1916 to control the power from conductors 1914 and 1912 to self cooling light source 1906 if clip contacts 1908 and 1920 connect to sensor/controller board 1918. In this case self cooling light source 1906 needs to exhibit a reasonable transmission to the IR. RF, UV and other wavelength ranges are also possible for control.

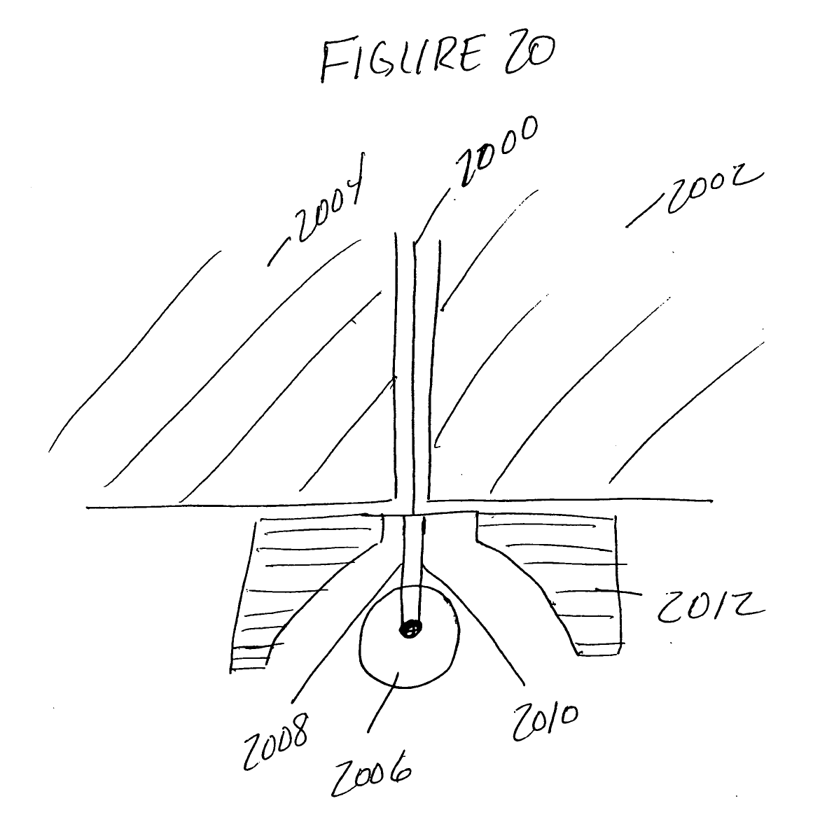

FIG. 20 is a side view of a self-cooling solid state light source that emits radially isotropically connected to a DC T grid. Self cooling light sources 2006 can be constructed as radially isotropic emitters. Electrical connections 2008 and 2010 provide not only power but also support for self cooling light source 2006 from grid 2000 which also supports ceiling tiles 2004 and 2002. Optionally, reflector 2012 may be additionally supported by grid 2000 to impart directionality.

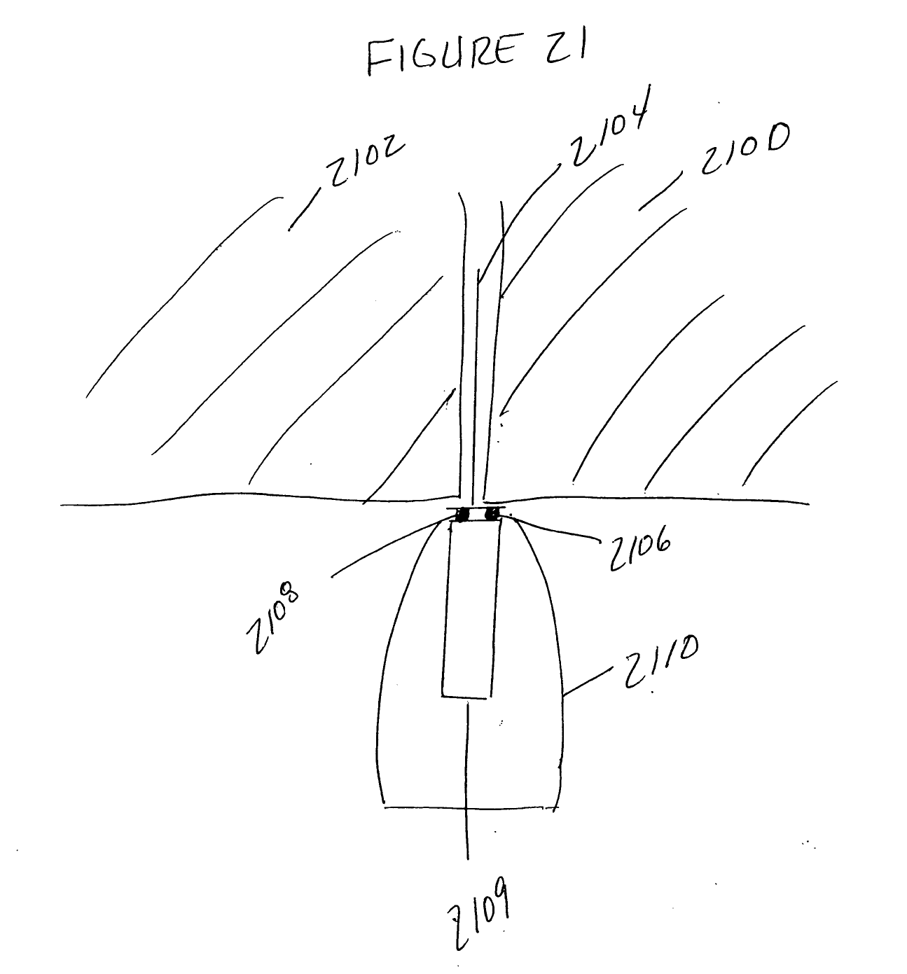

FIG. 21 is a single stick hanging vertically downward with an optional 3D CPC reflector. Self cooling light stick 2109 may be used with grid 2104 which also supports ceiling tiles 2100 and 2102. As shown, a narrow output angle CPC is attached to self cooling light stick 2109 which is further attached via magnetic contacts 2108 and 2106 to grid in a manner similar to previous examples. In this case, additional mechanical means may be required to support the fixture to the grid.

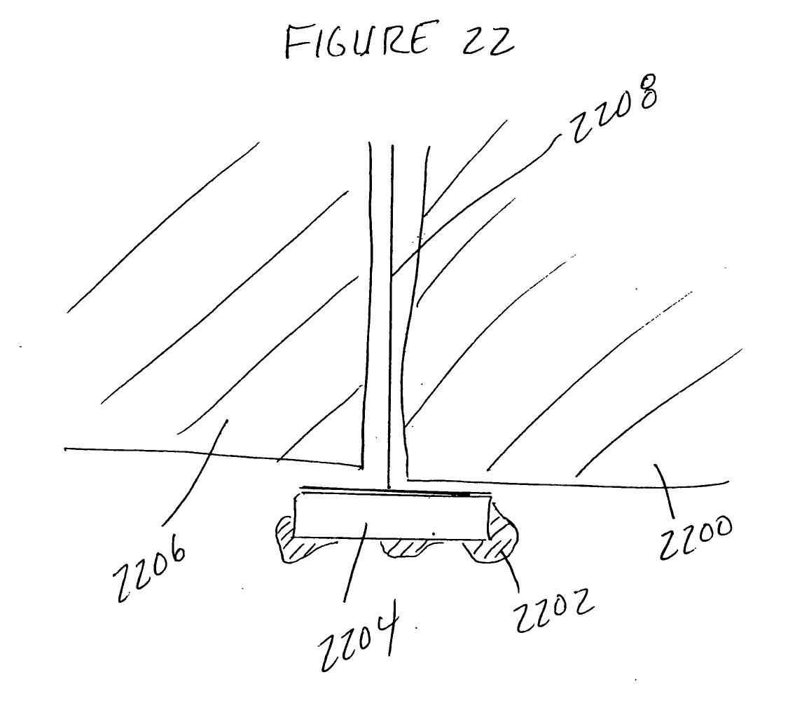

FIG. 22 is a side view of a self-cooling solid state light source with additional decorative elements supported by the self-cooling solid state light source. As previously stated, a wide range of materials may be used to form self cooling light sources 2204. Additional decorative or optically functional elements 2202 may be painted on, adhered to, printed on, affixed to and formed into the surface or bulk of self cooling light source 2204. Materials selected for these decorative elements would be selected based on their thermal conductivity so as to not impair the performance of the self cooling light source. In many cases, the look and cosmetic effect of the source is more important than the efficiency. A specific example is the use of black lamp shade over an incandescent bulb in dimly lit restaurant. As such, the formation of decorative or optically functional elements 2202 is disclosed. Again, the self cooling light source 2204 would electrically and mechanically attached to grid 2208 which also supports ceiling tiles 2206 and 2200.

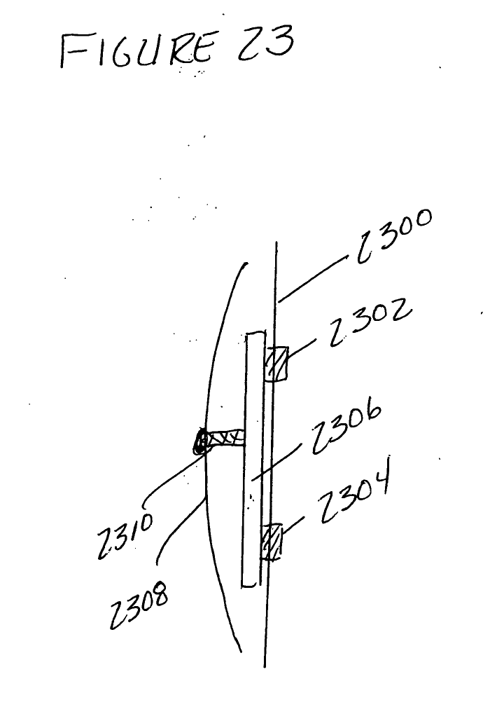

FIG. 23 is a side view of grid mounted wall sconce. Grids (not shown) can also be integrated into walls and floors. In this embodiment, contacts 2302 and 2304 would snap, twist, clip, or otherwise fasten into the grid (not shown) as previously discussed within the wall 2300. Self cooling light source 2306 may be substantially lambertian or substantially isotropic in emission nature. In many cases, isotropic emission is preferred to create a “wash” effect on the wall 2300. An additional diffuser element 2308 may be attached via clips 2310 to either the self cooling light source 2306 or the wall 2300 or via an additional support element (not shown) tied to the grid or combinations of these mounting choices. In general, the contacts 2302 and 2304 would be constructed to allow for adjustment, relocation, removal, and installation from the wall of interest or office space side as previously disclosed.

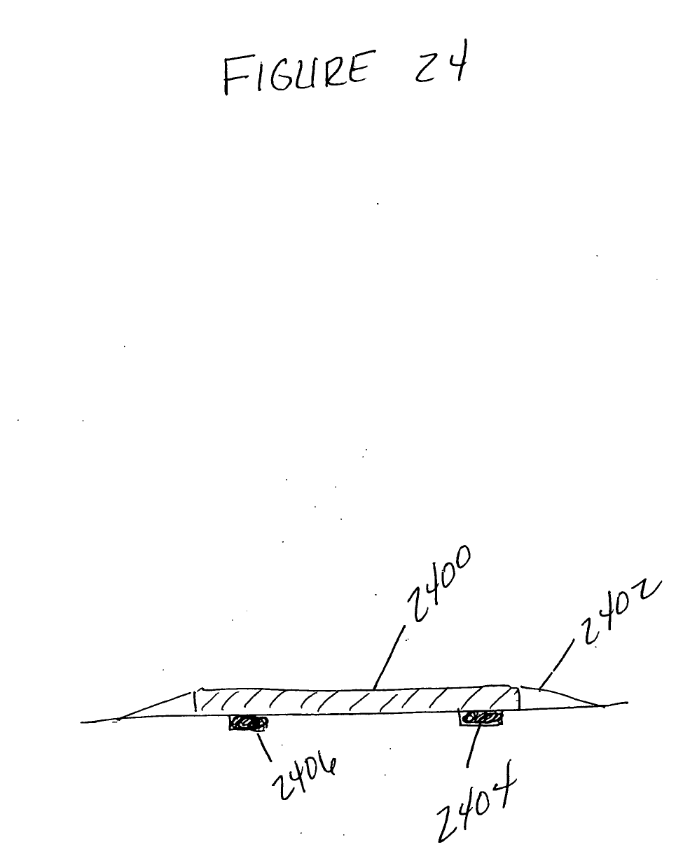

FIG. 24 is a side view of floor mounted lighting strip based on an embedded grid. In this embodiment, self cooling light source 2400 forms a walking surface for the floor. Additional structural elements 2402 may also be used to protect the self cooling light source 2400 from impacts and foot traffic. A grid (not shown) would be contacted via contacts 2404 and 2406 as previously disclosed. In this embodiment, durable materials such as translucent polycrystalline alumina, polycrystalline alumina, cubic zirconia, quartz, tempered glass, and other high durability translucent thermally conductive materials are preferred. It should be noted that the orientation of the cooling surface for the self cooling light source 2400 can have significant impact on the natural convection coefficient and should be taken into account in determining the maximum drive levels of the sources.

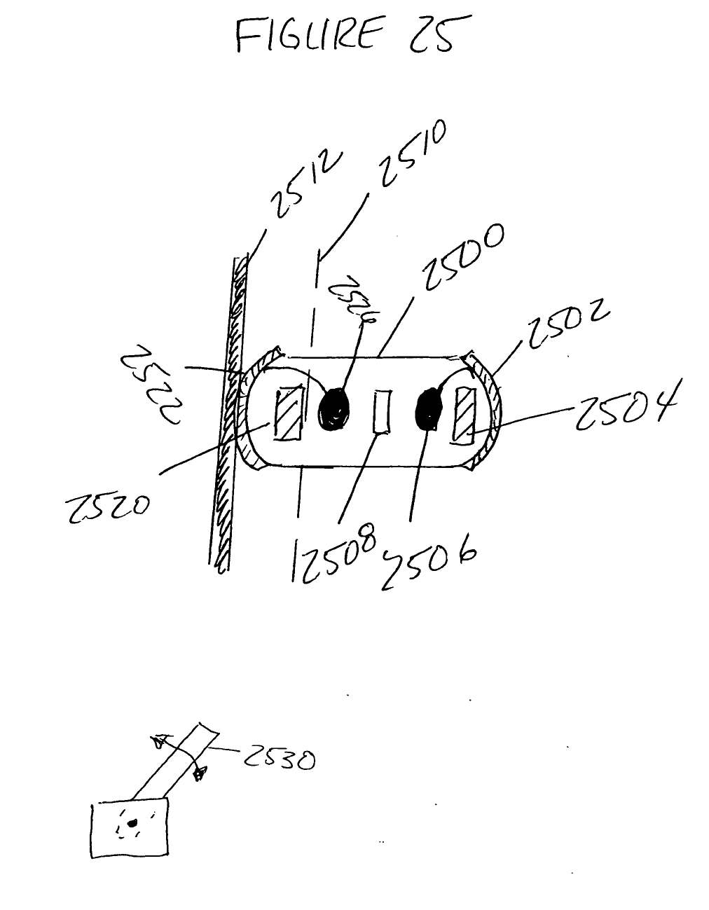

FIG. 25 is a magnetic twist connector for grid based strip lighting. In this embodiment, a dielectric support element 2500 contains two magnets 2504 and 2520 with field oriented to pull the contacts 2522 against conductor 2512 (one side shown). Pin contact 2526 is connected to contact 2522 to provide connection to the self cooling light source (not shown). Turning element 2508 is used to rotate connector once it is inserted into the channel of the grid. The turning element 2508 may be as simple as a slot for screwdriver or may include a pivoting lever arm 2530 as shown in the insert view. The use of locking or clipping elements for the pivoting lever arm 2530 are also disclosed to not only store the pivoting lever arm 2530 into the channel but also to further lock the support element into the channel.

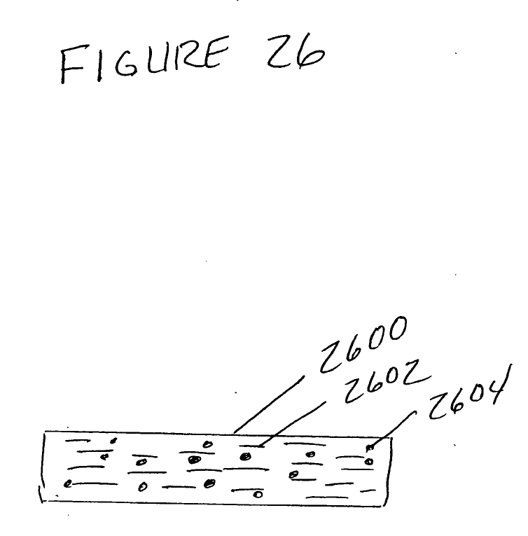

FIG. 26 is a translucent thermally conductive diffuser element based on boron nitride composites. As previously stated, the thermal conductivity has a major impact on the maximum brightness of a self cooling light source. Boron nitride, especially hexagonal boron nitride, has high optical transmission in the visible and also high thermal conductivity. As such, the formation of organic/inorganic composites using boron nitride flakes 2602 are preferred for translucent thermally conductive diffuser element. In plane, thermal conductivity in excess of 300 W/m/K has been measured for hexagonal boron nitride. In addition, the refractive index of hexagonal boron nitride is anisotropic (1.5 to 2.1). Proper orientation hexagonal boron nitride flakes 2602 and index matching of the organic matrix 2600 allows for the creation of highly anistropic diffusers with high inplane thermal conductivity with fairly low loading levels. As an example, hexagonal boron nitride flakes 2602 can be used to increase the inplane thermal conductivity of an organic matrix 2600 from 0.2 W/m/k to greater than 2 W/m/k while still maintaining reasonable translucency. The use of bimodal and mixed phase composites containing particles 2604 to further enhance thermal conductivity while maintaining reasonable translucency is also disclosed.

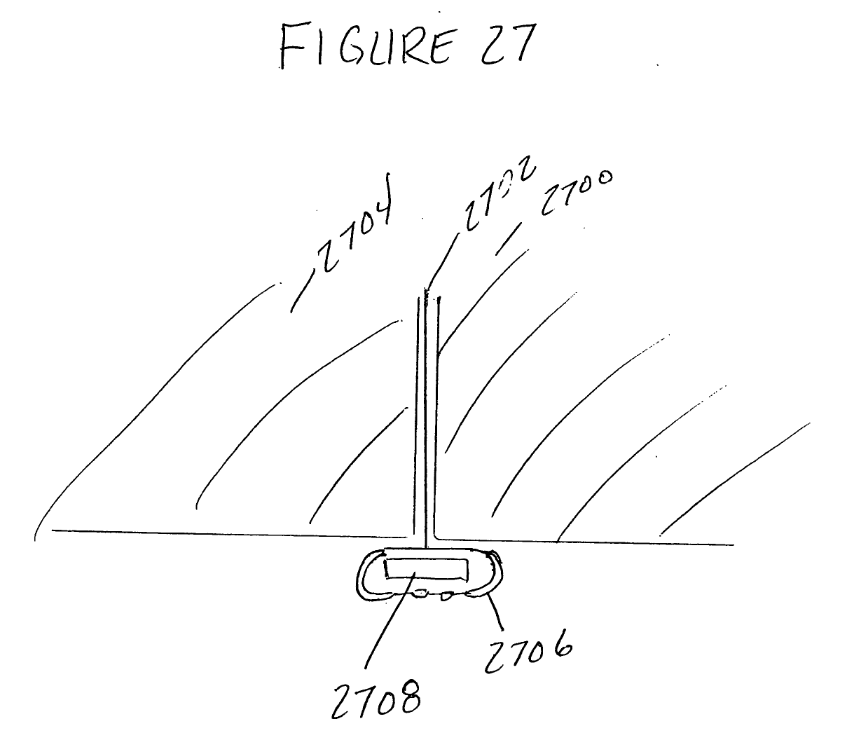

FIG. 27 is a strip light with an interchangeable decorative overlay. The grid 2702 supports ceiling tiles 2700 and 2704 as well as provides for electrical and mechanical support for self cooling panel light 2708. Decorative overlay 2706 may be attached to self cooling panel light 2708 or the grid 2702 or the ceiling tiles 2700 and 2704. Overlays are preferably elements that allow airflow through themselves to the self cooling light source. Examples of overlays include, but are not limited to, crystal beads, fabrics, meshes, glass elements, and other artistic elements.

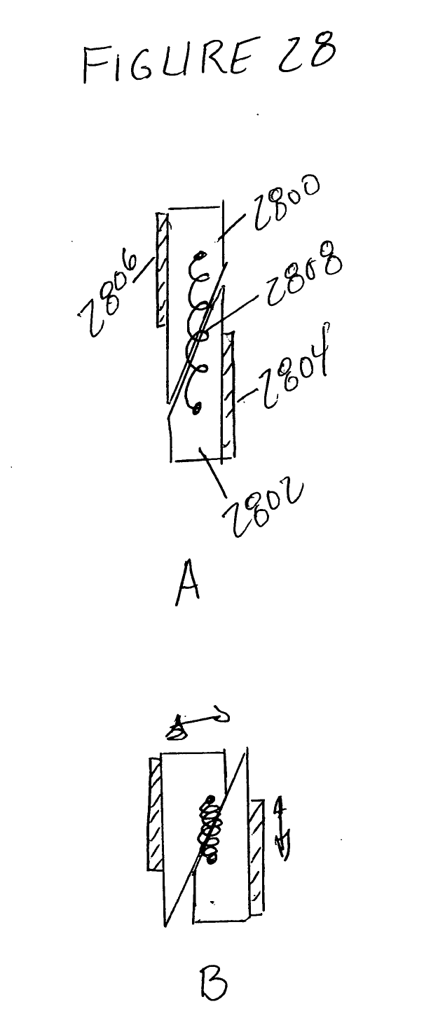

FIG. 28 is a spring based connector for grid lighting. In this embodiment, two opposing wedges 2800 and 2802 can slide past each other. A spring or tension element 2808 provides a force which tries to slide the wedges towards each other. As shown in FIG. 28A the condition with the least tension on the spring is when the contacts 2804 and 2806 are the farthest apart. FIG. 28A shows how the connector would be positioned to go into the channel and FIG. 28B shows how the connector would be positioned once in the channel. Contacts 2804 and 2806 would make contact with the grid conductors (not shown) and the spring or tension element 2808 would provide pressure between the grid conductor and associated contacts. Connection to the self-cooling light source would be via contacts, wires, clips as previously disclosed.

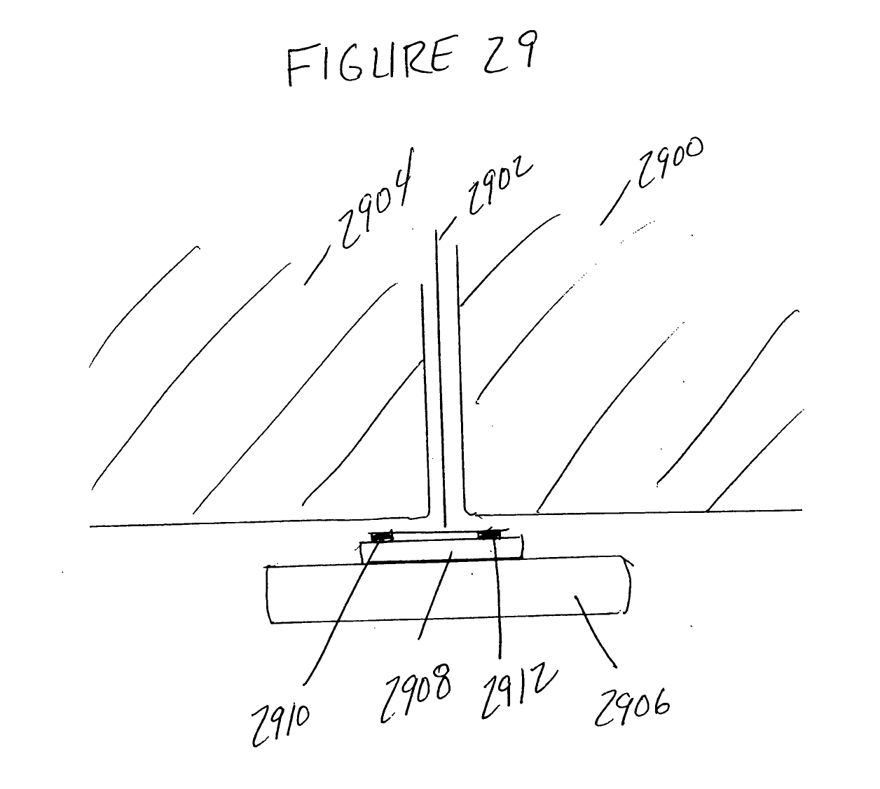

FIG. 29 is an integrated IR/WIFI controller for grid strip lighting. As previously disclosed, additional functionality can be imparted between the self cooling panel light 2906 and grid 2902. In this embodiment, an interface unit 2908 is transposed between the contacts 2910 and 2912 getting power from the grid 2902 which further supports ceiling tiles 2900 and 2904 and the self cooling panel light 2906. An RF antenna could be incorporated into either interface unit 2908 and/or self cooling panel light 2906. In this manner, active control of lighting and additional sensing functions can be retrofitted into the grid by the end users without requiring removal of ceiling tiles 2900 and 2904, replacement of the grid 2902, or skilled labor. The ability to meet this need is the elimination of the need for additional heatsinking means and light weight nature of the sources.

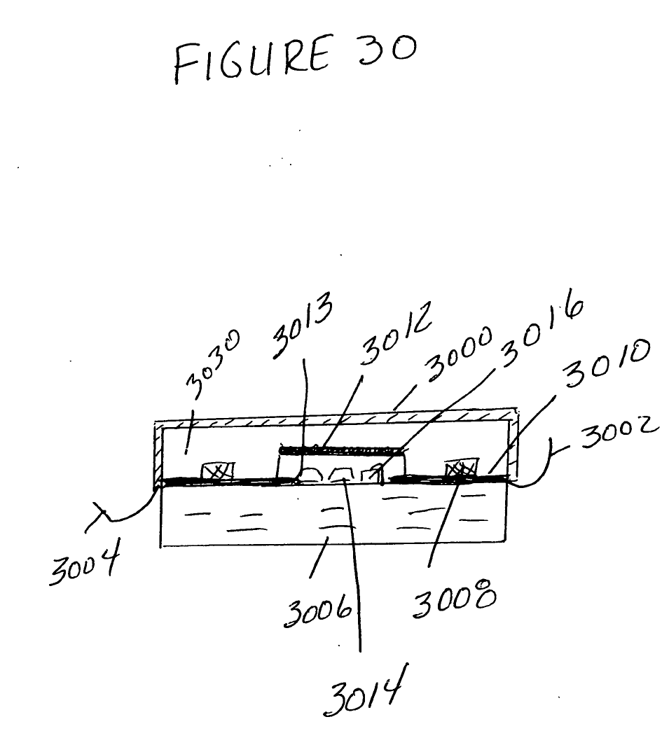

FIG. 30 is a RGB strip light containing a recycling light cavity in which multiple LED die 3013, 3014, and 3016 are mixed. The recycling light cavity is formed by the interconnect 3010 on the translucent thermally conductive element 3006 and the cavity reflector 3012. As previously disclosed, this approach allows for thinner waveguides and the embedding of the LEDs 3013, 3014, and 3016 within the emitting area of the sources. As long as the thickness of the translucent thermally conductive element 3006 is sufficiently large and there is sufficient scatter, there can be sufficient mixing of the red, green, and blue outputs. Additional wavelength conversion can occur in the waveguide 3030 using phosphor elements 3008 or on the back reflector 3000 or on/within the translucent thermally conductive element 3006. Contacts 3004 and 3002 can include wires, clips, pins and as well as the methods previously disclosed herein. Wavelength conversion may be based on powder, flake, rod, thin film coatings, or other coatings. As an example, a blend of garnet, oxynitride, nitride, aluminate, silicate, or sialon based phosphors such as may be supplied by Internatix, PhosphorTech, Nichia, and other powder phosphor suppliers may be used in these applications to modify the wavelength range emitted by the source. These powder blends may be dispersed within a transparent organic matrix such as silicone as known in the art. Alternately, quantum dot suspensions may also be used for wavelength conversion. As previously disclosed, solid thermally conductive luminescent elements may also be used as caps, flakes, covers, or elements within this filing. It should be noted that all the thermally conductive elements disclosed in this invention may also contain luminescent components within, on or bonded to them.

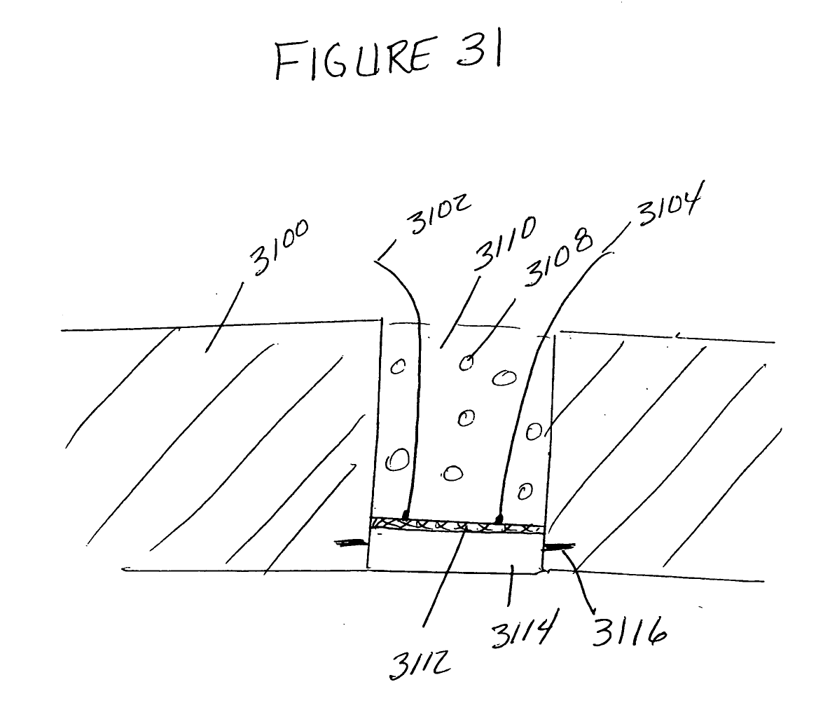

FIG. 31 is an embedded self cooling light within a ceiling tile 3100. Since the cooling is substantially done into the area to be illuminated or office space, self cooling panel lights 3114 can be directly embedded with the ceiling tiles 3100. Power would be supplied via wires 3102 and 3104 that may or may not be embedded into the ceiling tile 3100. The self cooling panel light 3114 may be mechanically fastened to, molded into, or otherwise integrated into the ceiling tile 3100 as long as the at least one surface (which in this invention is both emitting light and is thermally conductive is exposed to the area to be illuminated and or office space. Additional filler 3110 may be used to make up the extra thickness of the ceiling tile 3100 and this may include fillers 3108 such as fibers, particles or thermally conductive elements. A bonding layer 3112 may be used to adhesively adhere the self cooling panel light to the ceiling tile 3100 as well.

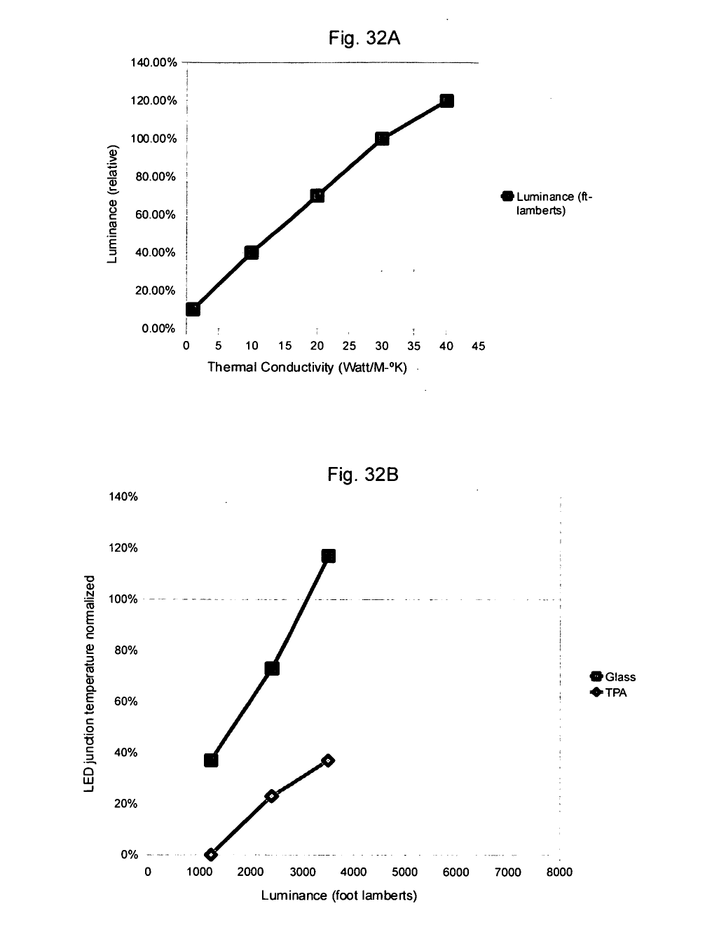

FIG. 32A is a graph of thermal conductivity of heat spreading elements versus FtL/lumens per inch for horizontal and vertical lighting sources. The graph illustrates the importance of thermal conductivity on the brightness for a fixed emitting area. As previously disclosed, the effective cooling area decreases due to inadequate heat spreading when low thermal conductivity sources are used. While this can be mitigated to some extent by using more LEDs such that the heat load is spread out this dramatically increases the costs because the main cost is in the LED die and in the assembly cost to attach the die to the thermally conductive translucent or luminescent elements. Packaged LEDs may also be used using this approach however the package adds its thermal impedance and therefore is not as efficient as using bare LEDs. Further, if the translucent thermally conductive elements have sufficient thermal conductivity and are compatible with direct attach or wire bonding there is no advantage to using packages. Packages also require more diffusion to create uniform panel lights. The use of small direct attach LED die is most preferred because it reduces costs and makes for more uniform panel lights.

Shown in 32B is the relative junction temperature of LEDs versus luminance as a function of thermal conductivity of the translucent thermal conductive element. Higher thermal conductivity provides lower LED junction temperature resulting in higher efficiency and longer life. Preferred is using a thermally conductive translucent element with a thermal conductivity of at least 10 Watt/M-° K. For lower luminance panels 1 watt/M-K will work. However having at least 4 Watt/M-K keeps the LED in a safer operating zone.

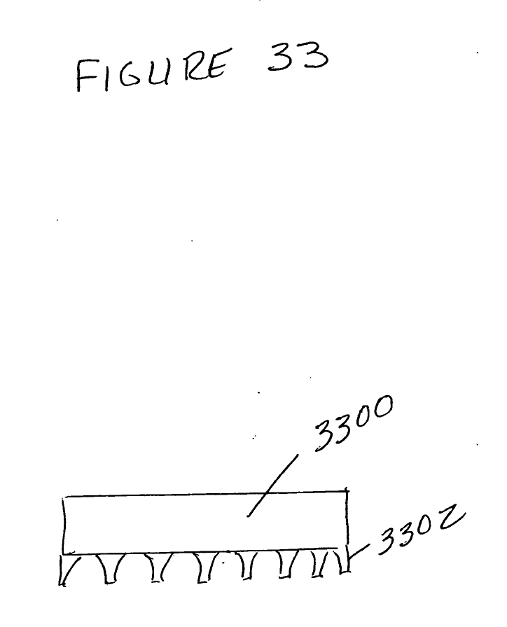

FIG. 33 shows optical directive light elements attached to a grid based strip lighting, Self cooling panel light 3300 is shown with micro optical reflectors 3302 bonded directly onto the panel light itself This allows for standardization on the self cooling panel light 3300. It also provides for very low profile glare free designs.

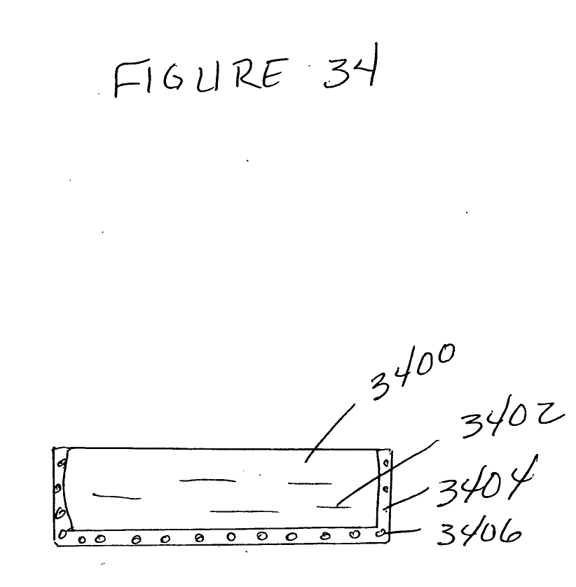

FIG. 34 depicts a colored thermal diffuser element with optional luminescent layer attached to a translucent thermally conductive element. The translucent thermally conductive element 3400 may consist of embedded luminescent elements 3402, coatings 3404 and the coating 3404 may or may not contain luminescent elements 3406. This combined with the previously disclosed examples allow for control of, not only emission, but also body color when the sources are off Aesthetics have a key role in the value proposition of office and residential spaces. In some cases, the desire is create a panel light which has a body color which is very white. In other cases a particular off white or decorative color may be desirable. This approach allows for user defined body color of the light sources in the off state as well as a variety of light emission spectra.

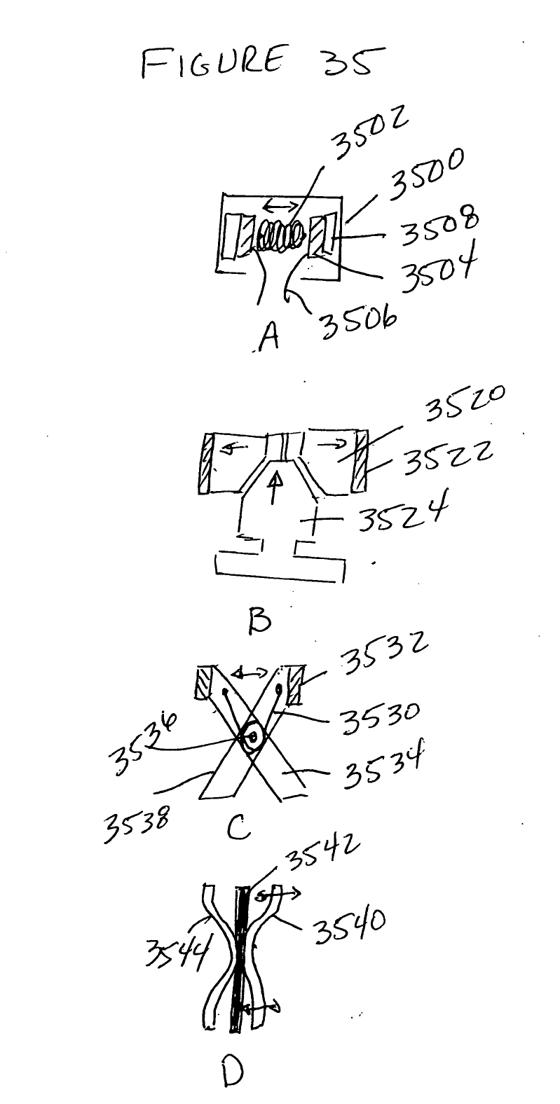

FIG. 35 depicts optional grid contacts for self-cooling strip lighting. In some cases, some form of mechanical attachment is desirable. The FlexDC grid allows for both magnetic and mechanical attachment.

FIG. 35A depicts a contact 3504 in contact with conductor 3508 within the grid 3500. A spring 3502 is trapped such that pressure is continuously applied the contact 3504 and conductor 2508 within the channel. External connection means 3506 is used to electrically and mechanically connect to the panel light (not shown).

Alternately as shown in FIG. 35B, rubbery, flexible, or bendable material such as rubber or plastics can used to form a collar 3520 that can be deformed using a piston element 3524. Contacts 3522 are again forced outward towards the conductors (not shown). Using this approach a snap fit can be formed and release can be via the use of tool or element which removes the piston element 3524 from the collar 3520 such that the contacts 3522 pull back.

FIG. 35C is based on a spring 3530, two lever arms 3534 and 3538 connected by pivot point 3536 such they move in manner similar to a pair of scissors. The contact 3532 moves again inward and outward based on the tension on spring 3530.

FIG. 35D depicts two leaf springs 3540 and 3544 separate by a dielectric support element 3542. In this case, spring steel or other spring contact material provides both the pressure for the contact as well as the contact itself. In all the cases above the use of additional elements to connect outside the grid channel to the self cooling panel light is assumed.

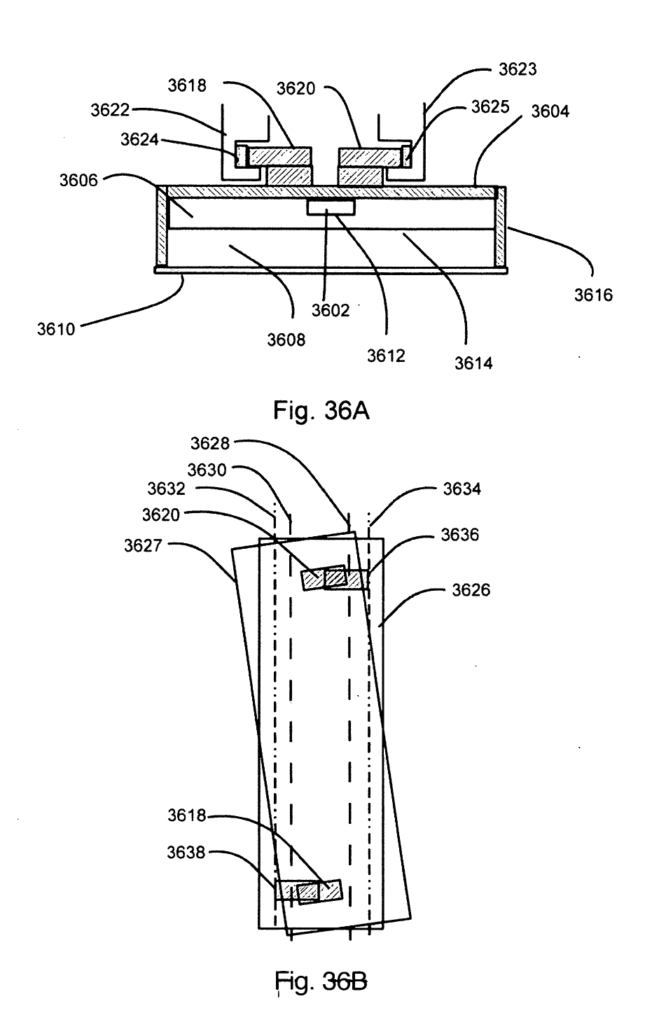

FIG. 36 shows an alternative method of making a self cooling solid-state panel light source for ceiling fixtures. Also shown in FIG. 36A and 36B is one preferred embodiment of making electrical contact and affixing the self cooling panel light source to the 24 V powered grid. This method of connecting the light source to the grid can be used in any of the embodiments of the light source described herein. In this method, electrical contact is made via posts 3618 and 3620. These posts are connected to the LEDs in a manner previously described via an isolated reflective and electrically conductive reflector or by using vias to LED contacts. The posts 3611 and 3613 have magnets attached to their overhanging ends which are attracted to the ferrous metal T grid behind the electrical rails 3625 and 3624. There is a thin electrically insulating sleeve (not shown) between the T-bar grid 3623 and 3622 and the electrically conductive rails 3624 and 3625. The posts are offset on opposite sides of the center line down the length of the light panel. With this arrangement the light panel (3626 and 3627) can be rotated 3627 slightly (see FIG. 36B) to line up the two posts 3620 and 3618 so they fit between the opening (depicted by the dashed lines 3628 and 3630) between the lower lips of the T. grid, inserted and then rotated straight 3626 where the magnets 3638 and 3636 make contact with the electrically conductive rails (depicted by the dot dash line 3632 and 3634).

FIG. 36B is an end view of the light panels and the posts in the locked and connected position. Provides an elegant and very easy method of inserting and attaching light panels to the electrically powered grid. This can be easily done by occupants in the room to be illuminated and doesn't require any special tools. In this way occupancy can easily customize their office space to put light where they so desire. Also shown in FIG. 36A is an alternative method of forming the self cooling white panel light source. In this embodiment the LED 3602 is connected to an electrically conductive and thermally conductive reflector. The reflector 3604 has a dialectic and an interconnect (not shown) to electrically connect to the LED. The LED is also in close thermal contact with the reflector. The reflector 3604 can be made out of aluminum or other such reflective conductor and can be 1 mm thick. A waveguide 3606 waveguides light emitted by the LED to spread the light out before it exits the waveguide. A small air gap 3606 between waveguide and a diffuser panel 3610 provides further diffusion of light to provide uniform emission exiting the diffuser panel 3610. The diffuser panel could be made with a plastic, glass, or other such material. In this case the emitting panel does not need to be thermally conductive. The heat from the LEDs is conducted through the reflector and down the exposed sides which would be exposed to the ambient room being illuminated. Even with a thin panel (2 mm-5 mm) if the brightness of the light panel does not exceed 3000 foot lamberts this method of cooling LEDs could be sufficient in properly cooled air conditioned rooms.

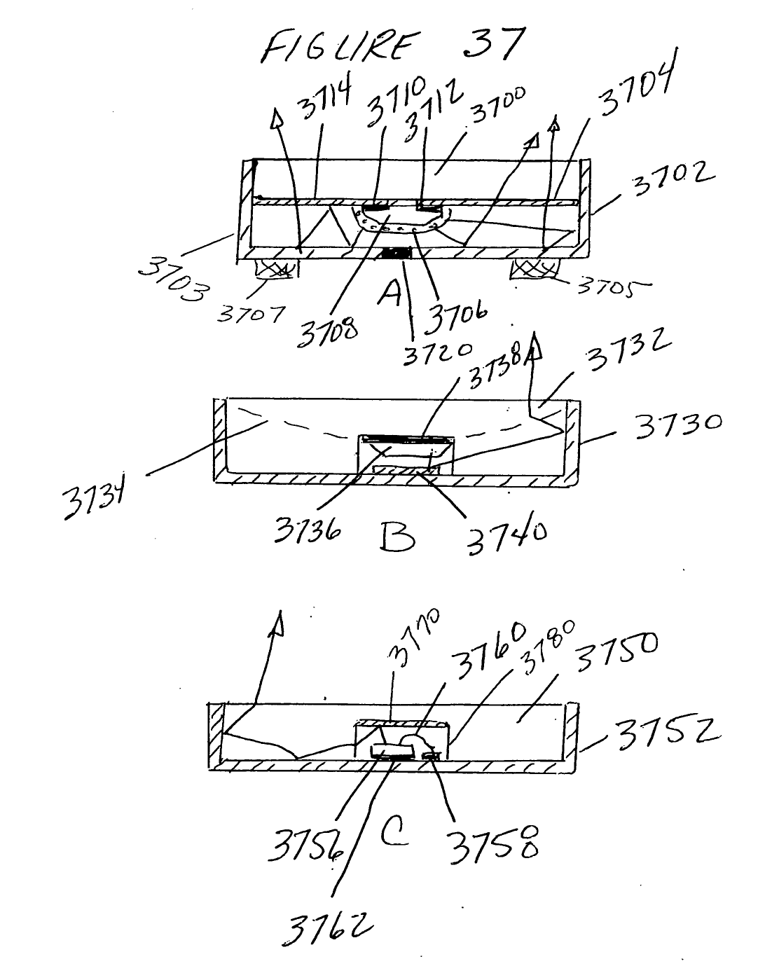

FIG. 37A depicts a self-cooling emitter with a translucent thermally conductive diffuser 3700 onto which direct attach LED die 3708 is soldered to interconnect 3704 and 3714 through contacts 3712 and 3710 respectively. Interconnect 3704 most preferably is a reflective silver or conductive trace formed on translucent thermally conductive diffuser 3700. While the side view does not depict what amount of translucent thermally conductive diffuser 3700 is covered my interconnect 3704 and 3714 it is preferred that only sufficient coverage to allow for the current requirements of direct attach LED die 3708 be used. In this manner the majority of the light emitted by the direct attach LED die 3708 can be transmitted through translucent thermally conductive diffuser 3700. In this configuration a thin wavelength conversion layer 3706 is coated on direct attach LED die 3708 and the light from the LED is emitted in a direction opposite to the output emitting surface of the light source 3701. The light emitted from the LED and phosphor is distributed by forming a light box using reflector 3702 and 3703 which are electrically isolated by dielectric barrier 3720. Interconnect 3704 and 3714 attach electrically 3715 and 3716 to reflector 3702 and 3703 respectively such that the reflectors become the electrical contacts to the grid. Electrical contact to the DC grid are made through contacts 3705 and 3707 to reflector 3702 and 3703 respectively. Although the contacts shown are on the back of the reflector they may be positioned or configured to integrate to various configurations of channel ceiling tracks or grid. Contacts 3705 and 3707 may include clips, springs, screws, magnets, and other contact means.

FIG. 37B depicts a side view of self-cooling panel in which optical spreading occurs within the translucent thermally conductive waveguide/diffuser element 3732. The thermally conductive translucent element is formed with a trough such that the LED is embedded into the translucent thermally conductive element. The trough may formed by laser cut, molded, ground, pressed etc. In this configuration a composite material is preferred such as but not limited to glass, organic/inorganic composites, and bonded assemblies. As an example, a translucent glass layer and clear glass layer may be fused to form a boundary generally depicted by interface 3734. Again, a recycling cavity is formed as shown in which the direct attach LED die 3736 is soldered to fused silver interconnect 3738 and wavelength conversion element or phosphor 3740 is also within the recycling cavity. In this configuration, the interconnect 3738 not only thermally and electrically connects the direct attach LED die 3736 to the translucent thermally conductive waveguide/diffuser element 3732 but it also acts as a reflector for the recycling cavity. Using this approach the reflector 3730 may or may not be a metal or electrically conductive and may or may not be thermally attached to the translucent thermally conductive waveguide/diffuser element 3732. Most preferably reflector 3732 is thermally bonded to translucent thermally conductive waveguide/diffuser element 3732 such that the average thermal conductivity of the assembly is increased. In this manner lower thermal conductivity materials can be used for the translucent thermally conductive waveguide/diffuser element 3732. Optionally the reflector can be vacuum evaporated aluminum or silver or other such reflective metal. Or optionally the reflector may be a coating of titanium dioxide, barium sulfide, or other diffuse white material applied via dip, paint, or spray coating. The space between the LED and the reflector may be filled with an optical matching gel, epoxy, or other such material.

FIG. 37C depicts a further variation of this approach but in this configuration a wirebonded LED 3756 is connected to a reflector interconnect 3752 via contacts 3758 and 3756 (the full interconnect on reflector interconnect 3752 is not shown). The reflector may be split with a dielectric 3753 to isolate the two sides of the reflector as described in FIG. 37A. A recycling cavity is depicted with a top reflector 3770 preventing any rays from LED die 3756 exiting the translucent thermally conductive waveguide 3750 without being waveguided first. Light rays 3771 emitted by the LED 3756 reflect off the reflector 3770 and out into the translucent thermally conductive element. Optionally the reflector 3770 may be partially transmitting and partially reflecting such that the ratio of transmittance and reflectance is selected to provide a uniform light output across the emitting surface 3751 of the translucent thermally conductive element. As disclosed in the referenced patents, the sidewall 3780 and the top reflector 3770 are critical elements in defining a recycling cavity along with the reflectivity of the LED die 3756. Using these approaches and combinations of these approaches, light weight and thin self cooling light panels can be formed. As example, a 1 mm thick TPA with a 500 micron deep 300 micron wide trench can be used for translucent thermally conductive waveguide 3750, a 50 micron thick layer of silver ink can be fired onto the bottom of the trench to form reflector 3770 (for embodiment 37B, interconnect 3738 would be formed). While direct attached LED die 2756 is shown the use of wirebonded in both vertical and lateral configurations are also disclosed.

As an example, the TR series of LED die from Cree may be mounted within the trench and wire bonding and/or aerosol metal interconnect means may be used to electrically interconnect the LED die 3756. The appropriate reflectors would be assembled and a self-cooling light panel in which both the light emitting surface and cooling surfaces are substantially the same would be formed. In all the above cases, the intent is to create a thin uniform block of light from the embedded LED die point sources. As such the interconnects should be as narrow as possible while still providing the necessary current carrying capability. By incorporating a reasonable level of scatter at the surface or within the bulk the embedded devices and interconnects can be made to be substantially invisible from the office side of the installation. The resulting block of light is both robust and lightweight.

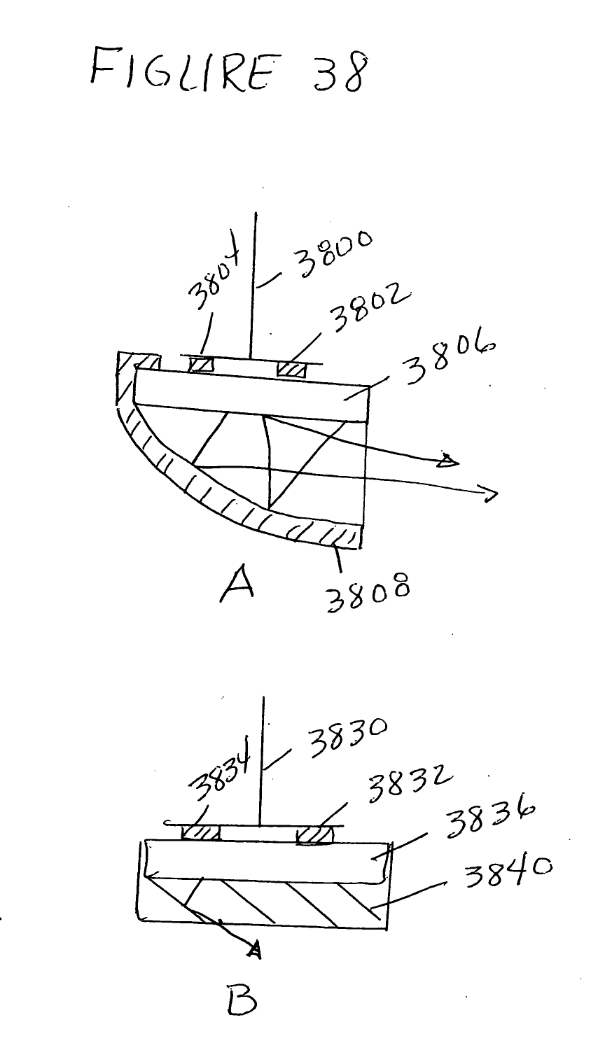

FIG. 38A depicts an off axis parabolic reflector 3808 mounted to self-cooling light panel 3806 for redirection of the light emitted as shown. Self-cooling light panel 3806 is electrically attached to the DC grid element 3800 using contacts 3804 and 3802 as previously disclosed.

FIG. 38B depicts a micro-louver 3840 attached to self-cooling light panel 3836. Light 3837 emitted from the panel light element is guided in a preferred direction by the reflective louvers 3840. Self-cooling light panel 3836 is electrically attached to DC grid element 3830 via contacts 3834 and 3832 as previously disclosed.

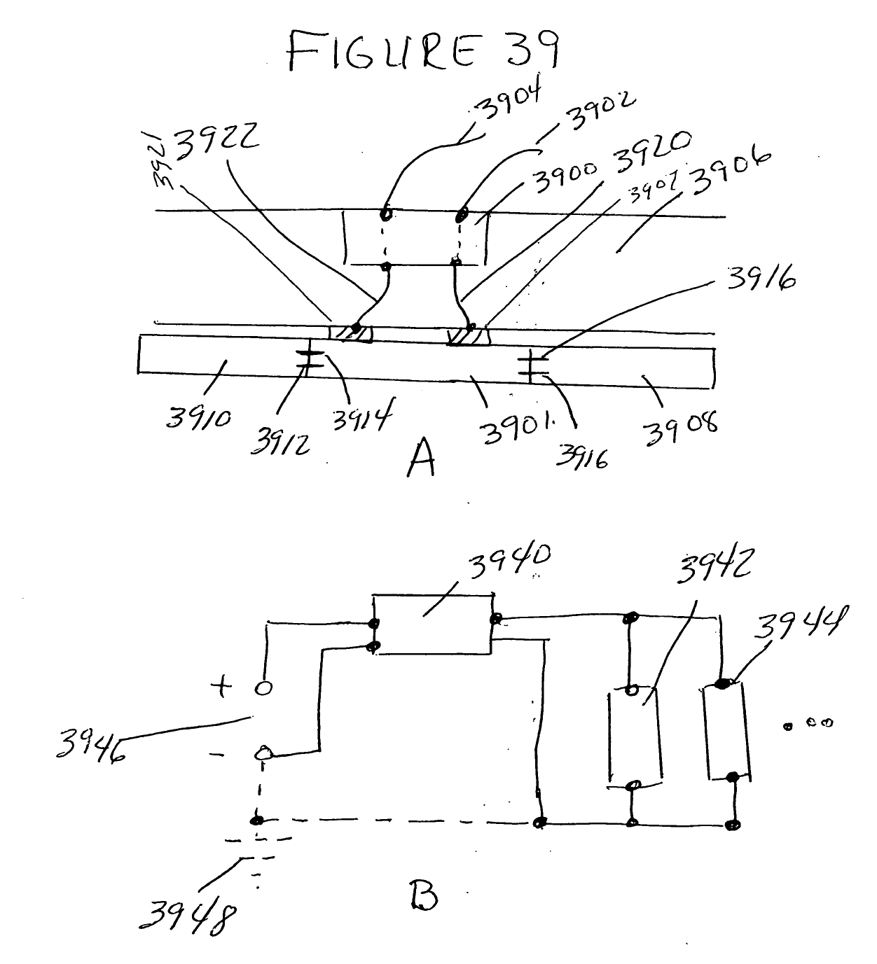

FIG. 39A depicts a lengthwise view of central controller module 3901 connected to DC grid element 3906. DC power is brought in via wires 3904 and 3902 to connector 3900 and then connected to the central controller module 3901 via wires 3922 and 3920 via contacts 3921 and 3907 respectively. The central controller module 3901 may provide remote dimming, occupancy detection, color control, light harvesting, surge protection, and power conditioning functions. The self-cooling light panels 3908 and 3910 are physically and/or electrically mounted to the central controller module 3901 via contacts 3916 and 3912 respectively.

FIG. 39B schematically depicts how central controller module 3940 can be used to control self-cooling light panels 3942 and 3944. DC voltage input 3946 may be floating or tied to a ground point 3948. Contacts 3916 and 3912 may be pin, spade or other contact means that plug into the central controller module 3901. Using this approach, multiple self cooling light panels 3908 and 3910 can be controlled independent of the DC power. This in particular can allow for wireless remote control off a single DC power supply. Alternately, central controller module 3901 may provide power conditioning and interconnect to other self cooling solid state light sources 3908 and 3910 such as but not limited to LED tapes, LED light bars, LED backlights, OLED panels, laser diodes, and electroluminescent panels. In this manner a wide range of light sources can be powered by the DC grid. As an example, a glass encapsulated OLED panel representing 3908 and/or 3910 may be connected into central controller module 3901 which includes a power converter to allow for 3 volt operation of the OLED panel. Optionally the OLED panel may be a display and the central controller module 3901 would could provide not only power conditioning but also wireless data links that could be displayed on the OLED display panel.

In general, central controller module 3901 connects to the DC grid element 3906 and interface to a variety of the light sources, information displays, sensors, and monitors. In this manner light harvesting, occupancy monitoring, ambient monitoring, and adaptive lighting can be realized. By providing a replaceable central controller module 3901 that can be attached to the office space side of the installation the end user can easily upgrade not only the lighting but other functionalities as well. This is all done without the need to remove ceiling tiles, replace grid elements, or run supports up to the deck. The central controller module 3901 can be lightweight because of the availability of DC from the grid element 3906 rather than AC. If AC were used transformers and other heavy elements would be required which could not be support by the grid and still meet seismic regulations. Most preferred is a low profile central controller module 3901 magnetically, mechanically, or otherwise attached to the DC grid element 3906 with a thickness less than 10 mm and more preferably less than 5 mm. The intent is to create a central controller module 3901 which aesthetically blends in to the suspended ceiling, wall, or floor.

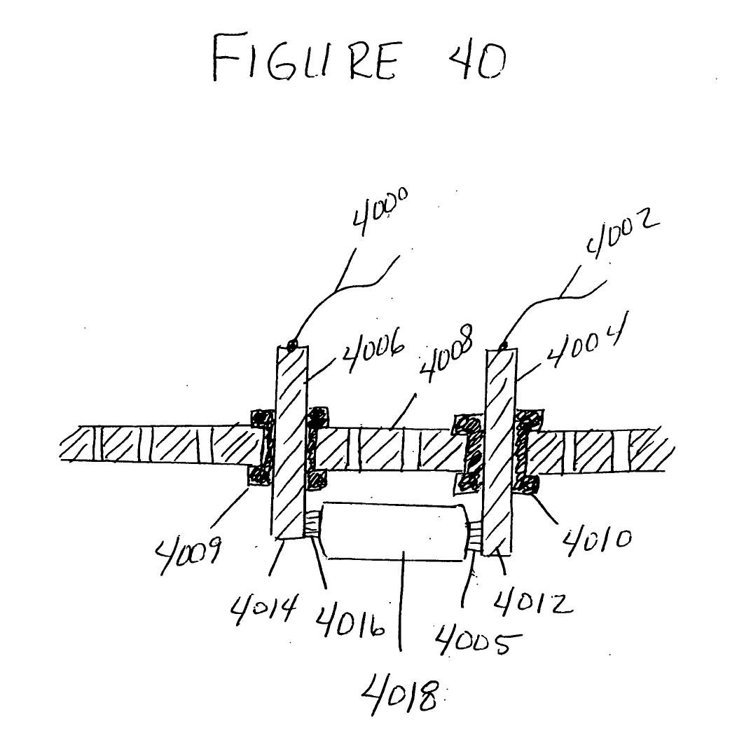

FIG. 40 depicts a perforated ceiling tile 4008 in which a self cooling light source 4018 is mounted. Power wires 4000 and 4002 are connected to feed thrus 4006 and 4004 respectively which are electrically isolated from the perforated ceiling tile 4008 (typically metal) via grommets 4009 and 4010 respectively. The self-cooling light source 4018 is contacted to feed thrus 4006 and 4004 via magnetic contacts 4016 and 4005 respectively. At least feed thru end 4014 and 4012 shall be ferromagnetic or magnetic in this configuration. Perforated ceiling tile 4008 can provide enhance acoustical control but also provides for enhanced natural convection for the self cooling light sources 4018 as compared to solid ceiling tiles. The enhanced air flow due to the holes in the ceiling tile 4008 allows for high output levels from the self-cooling light source 4018.

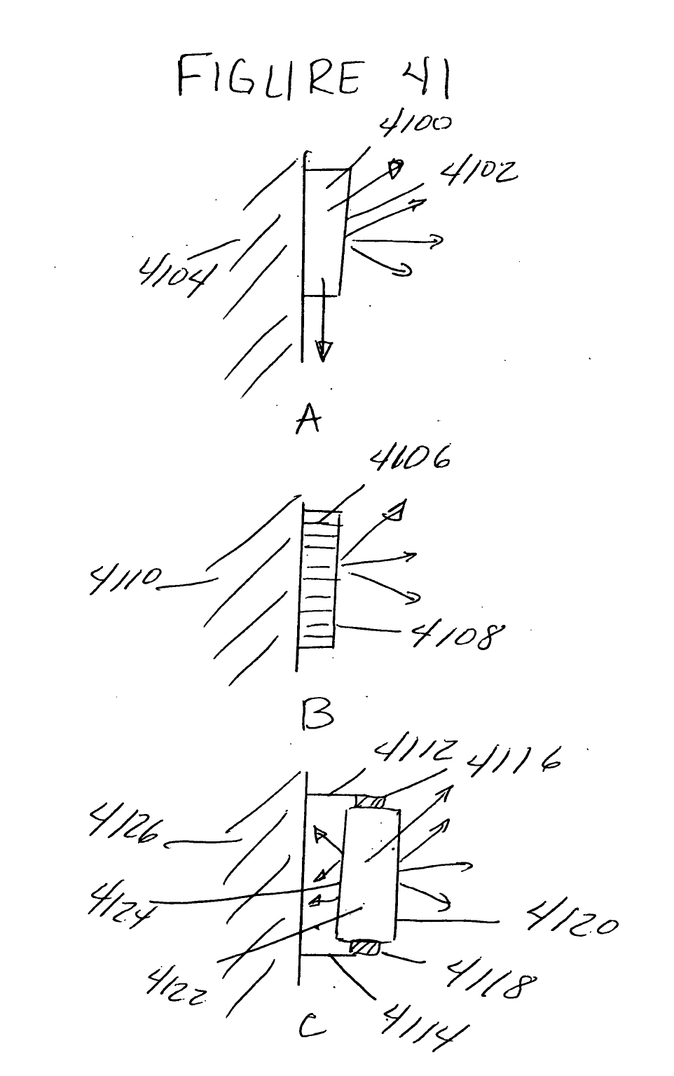

FIG. 41A depicts a self cooling light panel mounted onto wall 4104 in which light emits for edge surfaces 4100 and panel surface 4100. This configuration allows for increased numbers of optical rays which are substantially parallel to the wall surface 4104.

FIG. 41B depicts a self cooling light panel mounted onto wall 4110 in which edge surfaces 4106 are opaque and panel surface 4108 is transmitting. This configuration reduces optical rays which are parallel to the wall surface 4110.

FIG. 41C depicts an isotropic self cooling light source in which back panel surface 4124, edge surfaces 4122, and front panel surface 4120 all emit light forming a substantially radially isotropic light source slight above the surface of wall 4126. Using this approach leads 4112 and 4114 are used to support and electrically connect to contacts 4116 and 4118 respectively to support and power the isotropic self cooling light source. In each of these configurations a different far field intensity distribution is possible. In addition the optical extent of the sources is drastically different ranging from less than lambertian to approaching isotropic. This allows for a wide range of lens, diffuser, micro-optical, and reflector designs. It should be noted that the last embodiment allows for illumination of the wall 4126 which may or may not also contain optical elements like waveguides, diffusers, reflective elements and decorative elements.

While the invention has been described with the inclusion of specific embodiments and examples, it is evident to those skilled in the art that many alternatives, modifications and variations will be evident in light of the foregoing descriptions. Accordingly, the invention is intended to embrace all such alternatives, modifications and variations that fall within the spirit and scope of the appended claims.

1. A self-cooling suspended ceiling solid state light fixture comprising
at least one self-cooling solid state panel light wherein the emitting and cooling surfaces of the at the least one self-cooling solid state panel light are substantially the same.

2. The self-cooling suspended ceiling solid state light fixture of claim 1 wherein substantially all the heat generated is transferred to the illuminated side of the installation.

3. The self-cooling suspended ceiling solid state light fixture of claim 1 comprising
at least one thermally conductive translucent element, at least one LED, at least one electrical interconnect, and optionally at least one wavelength conversion element.

4. The self cooling suspended ceiling solid state light fixture of claim 3 wherein the at least one LED and at least one electrical interconnect are mounted to said at least one thermally conductive translucent element.

5. The self cooling suspended ceiling solid state light fixture of claim 3 wherein the at least one wavelength conversion element is on the surface of, within, or otherwise mounted to the at least one thermally conductive translucent element.

6. The self-cooling suspended ceiling solid state light fixture of claim 3 wherein the LED is mounted and interconnected either imbedded or on the surface of the thermally conductive translucent element

7. The self-cooling suspended ceiling solid state light fixture of claim 3 wherein the LED is mounted and interconnected either imbedded into or on the surface of the thermally conductive translucent element and the LED is position to that light emitted by the LED is directed away from the output surface of the light source.

8. The self-cooling suspended ceiling solid state light fixture of claim 7 where the light that is emitted by the LED is reflected by a back reflector and then passes back through the translucent thermally conductive element before being emitted by the panel light source.
